(19) United States
(12) Patent Application Publication
(10) Pub. No.: US 2026/0359802 A1
(43) Pub. Date: Nov. 12, 2026

(54) MODULAR POINT-OF-SALE PLATFORM WITH DISPLAY AND HARDWARE INTERFACE

(71) Applicant: Xenial, Inc., Charlotte, NC (US)

(72) Inventors: Christopher Paul Siefken, Charlotte, NC (US); Arjun Wadwalkar, Charlotte, NC (US)

(73) Assignee: Xenial, Inc., Charlotte, NC (US)

(21) Appl. No.: 19/674,729

(22) Filed: May 12, 2026

Related U.S. Application Data
(60) Provisional application No. 63/804,229, filed on May 12, 2025.
(60) Provisional application No. 63/838,220, filed on Jul. 3, 2025.
(60) Provisional application No. 63/864,098, filed on Aug. 14, 2025.
(60) Provisional application No. 63/888,960, filed on Sep. 26, 2025.
(60) Provisional application No. 63/962,069, filed on Jan. 16, 2026.

(51) Int. Cl. G06Q 20/20

(52) U.S. Cl. CPC G06Q 20/20

(57) ABSTRACT

A terminal for a point-of-sale system includes a stand including a first attachment arm and a second attachment arm; a first display assembly including a first housing removably coupled to the first attachment arm, a first display disposed in the first housing, and a controller coupled to the first housing; and a second display assembly including a second housing removably coupled to the second attachment arm and a second display disposed in the second housing. The first display assembly faces opposite from the second display assembly, and the controller is configured to control operation of the first display and the second display.

### CROSS-REFERENCE TO RELATED PATENT APPLICATIONS

This application claims the benefit of and priority to U.S. Provisional Application No. 63/804,229, filed on May 12, 2025, U.S. Provisional Application No. 63/838,220, filed on Jul. 3, 2025, U.S. Provisional Application No. 63/864,098, filed on Aug. 14, 2025, U.S. Provisional Application No. 63/888,960, filed on Sep. 26, 2025, and U.S. Provisional Application No. 63/962,069, filed on Jan. 16, 2026, the entire disclosures of each of which are hereby incorporated by reference herein.

### FIELD

The present application relates generally to the field of point-of-sale (POS) terminals.

### BACKGROUND

Point-of-sale (POS) systems may include one or more displays used during a transaction involving a customer. For example, a POS system at a store may include a display that is readily visible to an employee of the store, e.g., to show a list of items for purchase and a cost associated with each item. A second display may face the customer and may facilitate completion of a sales transaction, e.g., based in part on acquisition of a customer’s payment information or confirmation, e.g., through an interactive interface.

### SUMMARY

In an embodiment, a terminal for a point-of-sale system includes a stand including a first attachment arm and a second attachment arm; a first display assembly including a first housing removably coupled to the first attachment arm, a first display disposed in the first housing, and a controller coupled to the first housing; and a second display assembly including a second housing removably coupled to the second attachment arm and a second display disposed in the second housing. The first display assembly faces opposite the second display assembly, and the controller is configured to control operation of the first display and the second display.

In another embodiment, a point-of-sale (POS) system includes a display assembly including a housing, a display disposed in the housing, a first interface port coupled to the housing, and a controller coupled to the housing and in communication with the first interface port; a stand including a base assembly, a column extending upward from the base assembly, and an attachment arm configured to be removably coupled to the housing; and a hub including a plurality of second interface ports. The hub is configured to be coupled to the first interface port to operatively couple the second interface ports with the controller. In a first configuration, the housing of the display assembly is coupled to the attachment arm of the stand, and the hub is received within the column of the stand. In a second configuration, the housing of the display assembly is disconnected from the stand and the hub is directly coupled to the housing of the display assembly.

In yet another embodiment, a method includes: providing a stand including a base assembly, a column extending upward from the base assembly, a first attachment arm coupled to the column, and a second attachment arm coupled to the column; assembling a communication hub with the column; providing a first display assembly including a first display disposed on a first side of the first display assembly, a first mounting interface disposed on a second side of the first display assembly, opposite from the first side of the first display assembly, and a controller configured to control the first display; coupling the first mounting interface to the first attachment arm of the stand; providing a second display assembly including a second display disposed on a first side of the second display assembly and a second mounting interface disposed on a second side of the second display assembly, opposite from the first side of the second display assembly; coupling the second mounting interface to the second attachment arm of the stand such that the first display and the second display each face in opposing directions; and connecting the second display to the controller through the communication hub.

In yet another embodiment, a kiosk for a point-of-sale system includes: a display; a controller configured to control the display to display a graphical user interface (GUI) to present information related to a transaction; a housing containing the display and the controller; a stand including a base assembly and an interface portion coupled to a side of the housing opposite the display, the interface portion extending above the base assembly; and a printer positioned within the interface portion. The controller is configured to control the printer to print a receipt containing the information related to the transaction.

### BRIEF DESCRIPTION OF THE DRAWINGS

The details of one or more embodiments are set forth in the accompanying drawings and the description below. Other features, aspects, and advantages of the disclosure will become apparent from the description, the drawings, and the claims. In the drawings, like reference numerals are used throughout the various views to designate like components.

FIG. 1 is a block diagram illustrating an architecture for a Point-of-Sale (POS) system that can be employed to implement elements of the systems and methods described and illustrated herein, in accordance with at least one embodiment.

FIG. 2 is a perspective view of a first POS terminal and a second POS terminal, in accordance with at least one embodiment.

FIGS. 3 and 4 are various views of the first POS terminal of FIG. 2, in accordance with at least one embodiment.

FIGS. 5–8 are various views of a merchant-facing display assembly, in accordance with at least one embodiment.

FIG. 9 is a perspective view of the second POS terminal of FIG. 2 equipped with a magnetic stripe reader assembly, in accordance with at least one embodiment.

FIG. 10 is a perspective view of the magnetic stripe reader assembly of FIG. 9, in accordance with at least one embodiment.

FIG. 11 is a perspective view of the second POS terminal of FIG. 2 equipped with a payment interface assembly, in accordance with at least one embodiment.

FIG. 12 is a perspective view of the payment interface assembly of FIG. 11, in accordance with at least one embodiment.

FIG. 13 is a perspective view of the second POS terminal of FIG. 2 equipped with a fingerprint reader, in accordance with at least one embodiment.

FIG. 14 is a perspective view of the fingerprint reader of FIG. 13, in accordance with at least one embodiment.

FIGS. 15–17 are various views of a customer-facing display assembly for a POS terminal, in accordance with at least one embodiment.

FIGS. 18–20 are various views of a customer-facing display assembly for a POS terminal, in accordance with at least one embodiment.

FIGS. 21–24 are various views of an expansion hub for a POS terminal, in accordance with at least one embodiment.

FIG. 25 is a rear view of an expansion hub for a POS terminal, in accordance with at least one embodiment.

FIG. 26 is a perspective view of a pair of merchant-facing display assemblies for a POS terminal and an expansion hub installed on one of the merchant-facing display assemblies, in accordance with at least one embodiment.

FIG. 27 illustrates a process for installing an expansion hub on a merchant-facing display assembly for a POS terminal, in accordance with at least one embodiment.

FIG. 28 is a side view of an expansion hub installed on a merchant-facing display assembly for a POS terminal, in accordance with at least one embodiment.

FIG. 29 is a perspective view of an expansion hub for a POS terminal in a disassembled configuration, in accordance with at least one embodiment.

FIG. 30 is a perspective view of a pair of the second POS terminals of FIG. 2 with one of the second POS terminals having a cable cover removed, in accordance with at least one embodiment.

FIG. 31 is a perspective view of a vertical stand for a POS terminal with an expansion hub being inserted into the vertical stand, in accordance with at least one embodiment.

FIG. 32 is a perspective view of a vertical stand for a POS terminal with an expansion hub installed into the vertical stand, in accordance with at least one embodiment.

FIG. 33 is a perspective view of a top for a vertical stand for a POS terminal, in accordance with at least one embodiment.

FIG. 34 is a section view of the first POS terminal of FIG. 2, in accordance with at least one embodiment.

FIG. 35 is a bottom perspective view of the first POS terminal of FIG. 2, in accordance with at least one embodiment.

FIG. 36 is a top perspective view of the first POS terminal of FIG. 2 with a top of a vertical stand removed, in accordance with at least one embodiment.

FIGS. 37–39 are various views of a pillar for a stand of a POS terminal, in accordance with at least one embodiment.

FIG. 40 is a bottom perspective view of the first POS terminal of FIG. 2 showing a cable routing aperture, in accordance with at least one embodiment.

FIG. 41 is a perspective view illustrating various configurations of customer-facing display assemblies, in accordance with at least one embodiment.

FIG. 42 is a perspective view of a customer-facing display assembly mounted on a low-profile stand, in accordance with at least one embodiment.

FIG. 43 is a perspective view of a customer-facing display assembly mounted on a low-profile stand, in accordance with at least one embodiment.

FIG. 44 is a side view of a customer-facing display assembly mounted on a low-profile stand, in accordance with at least one embodiment.

FIG. 45 is an exploded view of a customer-facing display assembly mounted on a low-profile stand, in accordance with at least one embodiment.

FIG. 46 is a perspective view of a POS terminal including a compact payment interface, in accordance with at least one embodiment.

FIG. 47 is a perspective view of a compact payment interface, in accordance with at least one embodiment.

FIG. 48 is a perspective view of a POS terminal having a customer-facing display in a horizontal orientation, in accordance with at least one embodiment.

FIG. 49 is a perspective view of a POS terminal having a customer-facing display in a vertical orientation, in accordance with at least one embodiment.

FIGS. 50A–50L illustrate various configurations of a POS terminal, in accordance with at least one embodiment.

FIG. 51 is a block diagram illustrating an architecture for a POS system that can be employed to implement elements of the systems and methods described and illustrated herein, in accordance with at least one embodiment.

FIG. 52 is a perspective view of a kiosk, in accordance with at least one embodiment.

FIG. 53 is a perspective view of a kiosk with a stand extension, in accordance with at least one embodiment.

FIG. 54 is a perspective view of a kiosk including a mount arm and a display assembly in a horizontal configuration, in accordance with at least one embodiment.

FIG. 55 is a perspective view of a kiosk including a mount arm and a display assembly in a vertical configuration, in accordance with at least one embodiment.

FIG. 56 is a front view of a display assembly for a kiosk, in accordance with at least one embodiment.

FIG. 57 is a front view of a display assembly for a kiosk, in accordance with at least one embodiment.

FIG. 58 is a front view of a display assembly for a kiosk, in accordance with at least one embodiment.

FIG. 59 is a perspective view of a kiosk including a light bar, in accordance with at least one embodiment.

FIG. 60 is a perspective view of a light bar for a kiosk, in accordance with at least one embodiment.

FIG. 61 is a perspective view of a kiosk including a front panel in an open position, in accordance with at least one embodiment.

FIG. 62 is a perspective view of a kiosk including a latch, in accordance with at least one embodiment.

FIG. 63 is a front view of a kiosk including an accessibility interface and a payment interface, in accordance with at least one embodiment.

FIG. 64 is a perspective view of a printer being inserted into a kiosk, in accordance with at least one embodiment.

FIG. 65 is a perspective view of a kiosk including a printer door, in accordance with at least one embodiment.

FIG. 66 is a front view of a latch 506 for a printer door of a kiosk, in accordance with at least one embodiment.

FIG. 67 is a perspective view of a kiosk including a low-profile stand and a display assembly, in accordance with at least one embodiment.

FIG. 68 is a perspective view of a kiosk including a mount arm and a display assembly in a horizontal configuration, in accordance with at least one embodiment.

It will be recognized that some or all of the figures are schematic representations for purposes of illustration. The figures are provided for the purpose of illustrating one or more embodiments with the explicit understanding that they will not be used to limit the scope or the meaning of the claims. For example, exemplary embodiments of POS terminals are not limiting of the claims, nor are the embodiments themselves limited to those POS terminals depicted in the figures.

### DETAILED DESCRIPTION

Various exemplary implementations are described hereinafter. It should be noted that the specific implementations are not intended as an exhaustive description or as a limitation to the broader aspects discussed herein. One aspect described in conjunction with a particular implementation is not necessarily limited to that implementation and can be practiced with any other implementation(s).

The following discussion is provided to aid the reader in understanding the disclosure and is not admitted to describe or include prior art thereto. Point-of-sale (POS) terminals are electronic devices used to process transactions in various environments, e.g., retail stores, restaurants, or service centers. POS terminals can facilitate the management of sales, inventory, or customer interactions, allowing efficient operations in the processing of or completing transactions or exchanges. However, as recognized by the inventors of the present application, certain POS systems may lack flexibility and scalability. For instance, such POS systems may be bulky (e.g., involving multiple cables), lack modularity, or may not support high-speed processing for desired tasks. In addition, POSs for outdoor or semi-outdoor use may not only be bulky but require additional performance and durability criteria.

To address these problems, a POS platform including a POS terminal according to the present disclosure provides enhanced modularity and performance, among other benefits. The POS terminal can include a merchant-facing display (MFD) with an integrated motherboard panel, at least one hub to support various connectivity, and a customer-facing display (CFD). The hub can be embedded in or coupled to a display (e.g., in-display hub) or a stand-mount. The CFD can include or be implemented with an integrated payment device. The POS terminal of the present disclosure can provide enhanced configurability while reducing installation complexity, thereby allowing component upgrades, kiosk-ready configurations, and minimal or reduced cable/wire visibility. In some embodiments, a POS terminal according to any of the embodiments described herein may be utilized at a retail establishment, such as a restaurant, having a drive-through (e.g., a dual-lane drive-through, a four-lane drive-through, etc.), an entertainment venue such as a stadium or other sports venue, etc. Illustrative examples of representative operating environments where such POS terminals may be utilized are set forth in International Publication No. WO 2025/250556 published Dec. 4, 2025, U.S. Patent Application Publication No. 2025/0390967 published Dec. 22, 2025, U.S. Patent Application Publication No. 2025/0182080 published Jun. 5, 2025, U.S. Patent Application Publication No. 2025/0293824 published Sep. 18, 2025, and International Application Publication No. WO 2025/029332, published Feb. 6, 2025, the entire contents of each of which are incorporated herein by reference, including for the operational context of POS terminal usage (including but not limited to drive-through environments) and POS interfacing with additional components as set forth therein.

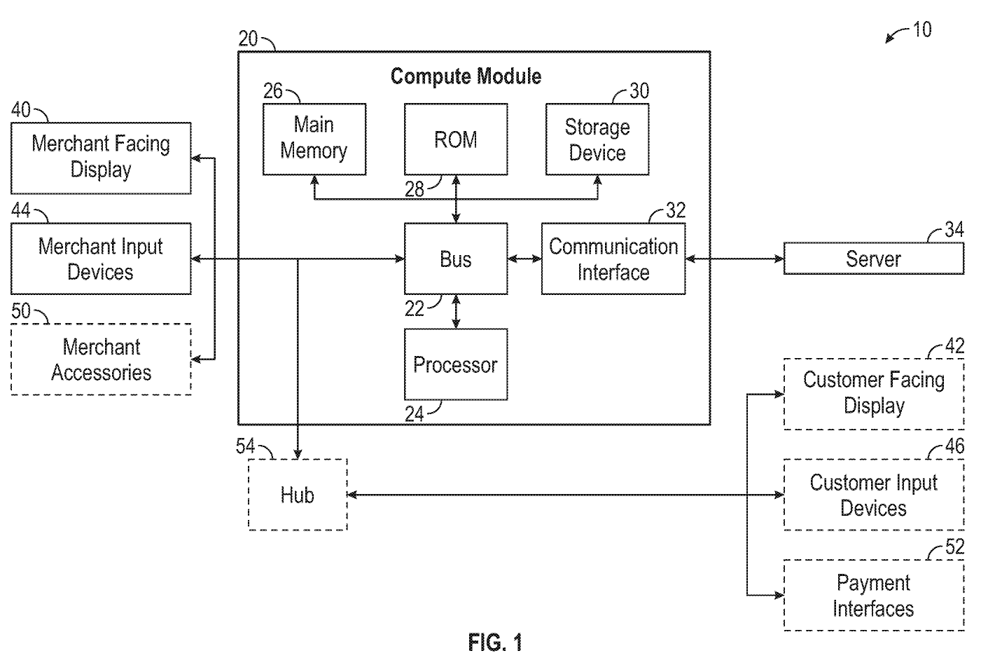

Referring to FIG. 1, a modular point-of-sale (POS) platform, POS system, payment system, inventory system, computing system, or sales system, is shown as POS system 10 according to an exemplary embodiment. The POS system 10 may be used by a first person, individual, or merchant (e.g., a cashier, an employee of a store or organization, etc.) and/or a second person, individual, or customer to complete a transaction. The transaction may include an exchange of goods (e.g., food, items, etc.), services, and/or financial instruments (e.g., cash, paper checks, electronic funds through credit or debit cards, etc.) between the customer and the merchant (e.g., the organization associated with the merchant). By way of example, the transaction may include a purchase of a food product at a restaurant, a return of a product in a retail store in exchange for previously-provided funds, a checking out of a book at a public library, or other types of transactions. During the transaction, the POS system 10 may facilitate identifying at least one good and/or service to be exchanged (e.g., a selection of a food order), identify a corresponding type and amount of financial instrument required for the transaction (e.g., a total cost of the order as well as how the customer intends to pay), initiate a transfer of funds (e.g., between a customer bank account or credit provider and a merchant bank account), and/or track changes in inventory (e.g., to identify sales metrics and when a particular good should be replenished). This action may be performed locally (e.g., within a restaurant or store) and/or remotely (e.g., through one or more remote servers).

Generally, the components of the POS system 10 may be used in combination with one another to form a POS terminal. Multiple of these POS terminals may be utilized in a store environment to process multiple transactions in parallel. Although FIG. 1 illustrates a single POS terminal, it should be understood that components of the POS system 10 may be duplicated or removed in other embodiments.

As shown in FIG. 1, the POS system 10 includes a controller, processing system, computer, or POS manager, shown as compute module 20. The compute module 20 is configured to exchange and process data to effect transactions. The compute module 20 may communicate with one or more local and/or remote devices to implement the POS terminal or its components. The compute module 20 includes at least one bus 22 or other communication component for communicating information and at least one processor 24 or processing circuit coupled to the bus 22 for processing information. The compute module 20 also includes at least one main memory 26, such as a random access memory (RAM) or other dynamic storage device, coupled to the bus 22 for storing information and instructions to be executed by the processor 24. The main memory 26 can also be used for storing position information, transaction data, customer profile information, command instructions, device status information, environmental information, information on characteristics of electricity, e.g., for diagnostics or fault collection information, or other information during execution of instructions by the at least one processor 24.

The at least one processor 24 can include multiple processors configured to individually or collectively process information and perform processing operations, e.g., in an individual or parallel manner or with operations distributed across any number of individual processors. The compute module 20 may further include at least one read-only memory (ROM) 28 or other static storage device coupled to the bus 22 for storing static information and instructions for the processor 24. A storage device 30, such as a solid-state device, magnetic disk, or optical disk, can be coupled to the bus 22 to persistently store information and instructions. Collectively, the at least one main memory 26, the ROM 28, and/or the storage device 30 may represent a memory or memory device for use with the processor 24.

In some embodiments, the compute module 20 represents multiple computing devices (e.g., each including a processor and a memory) cooperating with one another to perform the functions of the compute module 20 described herein. By way of example, a first computing device may manage the operation of the various POS terminal functionality (e.g., controlling displays, managing user inputs, etc.) and a second device may handle completion of a payment. In one such example, the first computing device receives a selection of an order to be purchased by a customer and provides a total cost to the second computing device. The second computing device may then manage payment information to execute a payment transaction for the total cost (e.g., with the server 34). By separating the POS terminal functionality and the payment functionality in different computing devices, the payment data may be isolated from the rest of the system to improve security.

The compute module 20 further includes a wired or wireless communication interface or network interface, shown as communication interface 32. The communication interface 32 may facilitate the compute module 20 communicating with one or more external devices. The communication interface 32 may communicate through a wired connection (e.g., Ethernet) and/or a wireless connection (e.g., Wi-Fi, Bluetooth, etc.). The communication interface 32 may communicate directly or over a network (e.g., a local area network, a wide area network, such as the Internet, etc.).

The communication interface 32 is configured to communicate with an external device or remote device, shown as server 34. The server 34 may be positioned locally (e.g., within the store containing the POS system 10) or remotely (e.g., at another location distant from the store). The server 34 may contain data utilized during the transaction. By way of example, the server 34 may contain financial data (e.g., the server may be part of a bank or credit provider), customer data (e.g., a profile associated with a particular customer), purchase data (e.g., data describing which items are purchased and when), inventory data (e.g., data describing the amount of items on hand), or other data. Throughout a transaction, the compute module 20 may send and receive data to confirm permissions for the transaction and to record the details of the transaction on the server 34.

The processes, systems, and methods described herein can be implemented by the compute module 20 in response to the processor 24 executing an arrangement of instructions contained in main memory 26. Such instructions can be read into main memory 26 from another computer-readable medium, such as the storage device 30. Execution of the arrangement of instructions contained in main memory 26 causes the compute module 20 to perform the illustrative processes described herein. One or more processors in a multi-processing arrangement may also be employed to execute the instructions contained in main memory 26. Hard-wired circuitry can be used in place of or in combination with software instructions, together with the systems and methods described herein. Systems and methods described herein are not limited to any specific combination of hardware circuitry and software.

As shown, the compute module 20 is coupled via the bus 22 to a pair of displays or visual output devices, shown as merchant-facing display (MFD) 40 and customer-facing display (CFD) 42. The displays may be liquid crystal displays, active matrix displays, or other types of displays for visually displaying information to a user. The MFD 40 may be controlled by the compute module 20 to display information (e.g., in the form of a graphical user interface (GUI)) that is relevant to the merchant (e.g., a GUI used to enter and complete a customer’s order). Accordingly, the MFD 40 may be positioned to be viewed by the merchant (e.g., on a merchant side of a store counter). The CFD 42 may be controlled by the compute module 20 to display information that is relevant to the customer (e.g., a GUI used to verify the accuracy and completeness of the customer’s order). Accordingly, the CFD 42 may be positioned to be viewed by the customer (e.g., on a customer side of a store counter, a direction opposite the MFD 40, etc.). The information on the CFD 42 can be presented in a streamlined format with flexible and customizable content delivery and ease of review by customers. This can reduce or alleviate customer anxiety associated with order decision-making and can reduce potential abandonment of orders while enhancing the customer experience.

The POS system 10 further includes a pair of input devices, shown as merchant input devices 44 and customer input devices 46, coupled to the bus 22 for communicating information and commands to the processor 24. The merchant input devices 44 and the customer input devices 46 can include a touch screen portion of the MFD 40 or the CFD 42, respectively. The merchant input devices 44 and the customer input devices 46 may include other input devices, such as a keyboard or voice interface. The merchant input devices 44 and the customer input devices 46 can also include a cursor control, such as a mouse, a trackball, or cursor direction keys, for communicating direction information and command selections to the processor 24 and for controlling cursor movement on the MFD 40 or the CFD 42.

The POS system 10 further includes one or more expansion devices, input devices, or accessories, shown as merchant accessories 50, operatively coupled to the processor 24 through the bus 22. The merchant accessories 50 may be added to the POS system 10 to provide additional functionality usable by the merchant. By way of example, the merchant accessories 50 may include a fingerprint reader that is configured to read a fingerprint of the merchant to verify the identity of the merchant (e.g., as part of a login process). By way of another example, the merchant accessories 50 may include a payment interface configured to receive the payment details of a customer. The payment interface may include a magnetic stripe reader, an inserted chip (e.g., EMV) reader, and/or a near-field communication (NFC) reader. The payment interface may communicate with a payment device, such as a payment card (e.g., a credit or debit card) and/or a user device (e.g., an NFC-enabled smartphone). The merchant accessories 50 may enable a merchant to receive a payment card from a customer and initiate a transaction from a merchant side of the POS terminal. In some embodiments, the merchant accessories 50 are removably coupled to the MFD 40, such that the merchant accessories 50 can be added or removed depending upon the specific functionality required by a merchant.

The POS system 10 further includes one or more payment interfaces 52. The payment interfaces 52 may be positioned to be utilized by a customer. The payment interfaces 52 may include a magnetic stripe reader, an inserted chip (e.g., EMV) reader, and/or a near-field communication (NFC) reader. The payment interfaces 52 may communicate with a payment card (e.g., a credit or debit card) and/or a user device (e.g., an NFC-enabled smartphone). The payment interfaces 52 may enable a customer to utilize a payment card or user device to initiate a transaction from a customer side of the POS terminal. The payment interfaces 52 may be coupled to or separate from the CFD 42.

The POS system 10 further includes an expansion device, expansion hub, or communication hub, shown as extension hub 54. The extension hub 54 is configured to facilitate communication between the bus 22 of the compute module 20 and one or more external devices, such as the CFD 42, the customer input devices 46, and/or the payment interfaces 52. The extension hub 54 may provide more and/or different types of communication interfaces (e.g., ports) than are available directly on the compute module 20. By way of example, the extension hub 54 may communicate with the compute module 20 through a single port (e.g., a Universal Serial Bus (USB) port) and provide several different types of ports for connection to the CFD 42, the customer input devices 46, and the payment interfaces 52. In other embodiments, the extension hub 54 is omitted from the POS system 10.

Beneficially, the POS system 10 may provide a series of modular components that are reconfigurable to suit a variety of different applications. By way of example, the POS system 10 may be provided in a configuration that omits the CFD 42, the customer input devices 46, the payment interfaces 52, and the extension hub 54 to form a POS terminal in which a merchant verbally communicates an order with a customer and the merchant completes a transaction on the MFD 40 without the POS terminal receiving a direct input from a customer. By way of another example, the POS system 10 may be provided in a configuration that includes an MFD 40 and a CFD 42 mounted to a single stand to permit a customer to review the contents of an order entered by the merchant through the MFD 40 and the merchant input devices 44. By way of an additional example, the POS system 10 may be provided in a configuration that includes an MFD 40 and a payment interface 52 but omits the CFD 42, such that the merchant may verbally communicate an order with a customer and the customer can directly interface a payment device with the payment interface 52 from the customer side of the POS terminal. Each of these applications may be serviced with a common set of components, providing the flexibility to suit a variety of merchant applications without a large, complex library of different components. Additionally, the POS system 10 may be easily reconfigured between different applications by adding or removing components based on a change in the required functionality of the POS system 10.

Although an example computing system has been described in FIG. 1, the subject matter, including the operations described in this specification, can be implemented in other types of digital electronic circuitry, or in computer software, firmware, or hardware, including the structures disclosed in this specification and their structural equivalents, or in combinations of one or more of them.

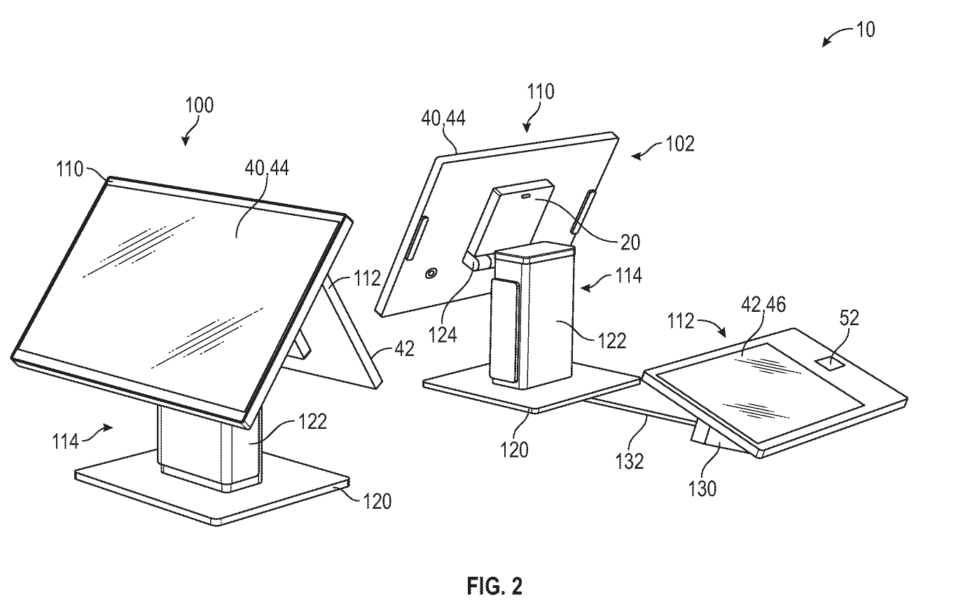

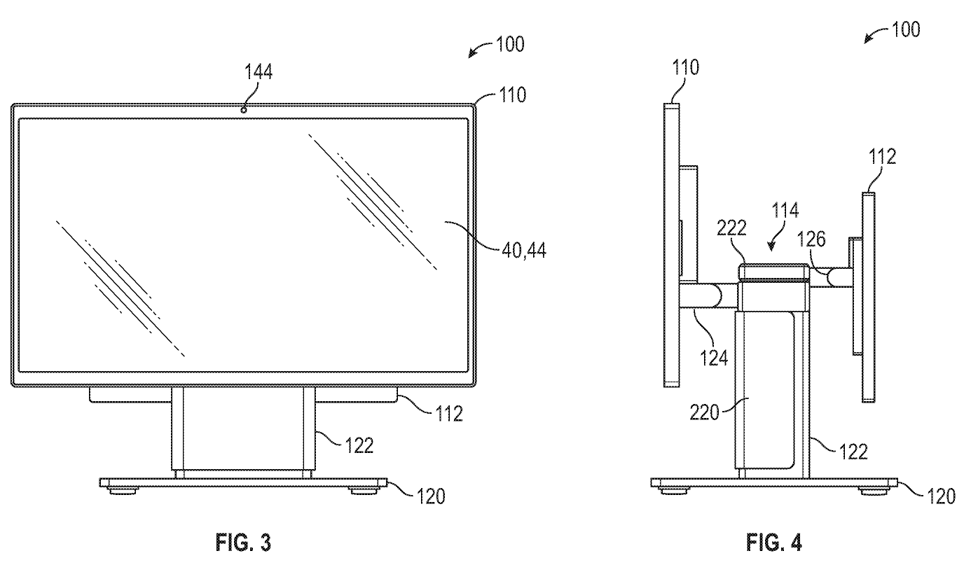

FIG. 2 includes two configurations of the POS system 10, showing the flexibility of the modular components of the POS system 10. The POS system 10 of FIG. 2 includes a first POS terminal configuration or dual-display terminal, shown as POS terminal 100, and a second POS terminal configuration or separated display terminal, shown as POS terminal 102. The POS terminal 100 and the POS terminal 102 can include or be composed of a plurality of components, such as a mounting structure with one or more attachment points, a first panel, and/or a second panel. FIGS. 3 and 4 provide additional views of the POS terminal 100.

As shown, the POS terminal 100 includes a merchant-facing display assembly or panel, shown as MFD assembly 110, a customer-facing display assembly or panel, shown as CFD assembly 112, and a support, arm, mounting structure, or holder, shown as vertical stand 114. The MFD assembly 110 includes the MFD 40, the merchant input devices 44, and the compute module 20. The CFD assembly 112 includes the CFD 42, the customer input devices 46, and the payment interfaces 52. The vertical stand 114 is coupled to and supports both the MFD assembly 110 and the CFD assembly 112, such that the CFD assembly 112 and the MFD assembly 110 face in opposing directions. The vertical stand 114 includes a base assembly, lower support, or base plate, shown as base assembly 120, and a support structure or upright portion, shown as support column 122, connected to the base assembly 120.

In at least one embodiment, the base assembly 120 may be or include a base plate, a supporting platform, a mounting plate, or a bottom portion of the vertical stand 114, for example. The support column 122 may be or include a vertical arm, a stand assembly, a pillar, a column, or a shaft assembly extending vertically from the base assembly 120. The vertical stand 114 further includes a pair of attachment points, mounting points, support arms, pivot joints, or attachment arms, shown as attachment point 124 and attachment point 126, extending outward from the support column 122. The attachment point 124 couples the MFD assembly 110 to the support column 122, and the attachment point 126 couples the CFD assembly 112 to the support column 122. As shown in FIG. 2, in the POS terminal 102 where the CFD assembly 112 is separated from the vertical stand 114, the attachment point 126 is omitted from the vertical stand 114. The components of the vertical stand 114 can be constructed or formed in any suitable or desired shape, including square, rectangle, triangle, oval, or circle, among others.

The mounting structure of the vertical stand 114 can be mounted with or coupled to one or more panels (e.g., the MFD assembly 110 and/or the CFD assembly 112). The one or more panels can be detached or decoupled from the vertical stand 114. For example, the POS terminal 100 is a terminal setup with the MFD assembly 110 and the CFD assembly 112 coupled to the mounting structure of the vertical stand 114. The MFD assembly 110 can include or may be referred to as a merchant-facing display. The CFD assembly 112 can include or may be referred to as a customer-facing display. The vertical stand 114 can include or be coupled with at least one attachment point, arm, joint, or other non-limiting coupling mechanisms (e.g., the attachment point 124 and the attachment point 126) suitable to couple the vertical stand 114 with at least one of the MFD assembly 110 or the CFD assembly 112. As discussed herein, the attachment point or joint (e.g., the attachment point 124 or the attachment point 126) can be configured to rotate around at least one axis. The MFD assembly 110 can be connected to the CFD assembly 112 via at least one connector, cable, or linkage via the vertical stand 114. For instance, the connector can be routed through the vertical stand 114 from the I/O port of the MFD assembly 110 to an I/O port of the CFD assembly 112.

In some cases, the attachment point 124 and/or the attachment point 126 can include a routing channel, a receiver or cavity, or an opening for routing the connector from one panel to another. In some implementations, the attachment point 124 and the attachment point 126 can be a connector or adapter for interconnecting the MFD assembly 110 and the CFD assembly 112 via the vertical stand 114. In some configurations, the vertical stand 114 can include a cavity or an opening for routing or managing cables/wires. With such configurations, the POS terminal 100 can conceal or limit the visibility of any cables, at least above the base assembly 120 of the POS terminal 100. In some configurations, power cables can be routed from under the base assembly 120 to the MFD assembly 110 and/or the CFD assembly 112, e.g., through a hole in a desk, platform, or counter disposed below the POS terminal 100, or from an outlet with a power cable routed under the POS terminal 100.

As shown in FIG. 2, the POS terminal 102 illustrates a terminal setup with the MFD assembly 110 coupled to the vertical stand 114. The vertical stand 114 can include an integrated hub or a removable hub (e.g., the extension hub 54). The POS terminal 102 further includes the CFD assembly 112 decoupled or detached from the vertical stand 114. The attachment point 126 can be detached from the vertical stand 114. The CFD assembly 112 can be operated in a standalone mode, without mounting to the vertical stand 114. The CFD assembly 112 is instead coupled to a separate angled stand or base, shown as low-profile stand 130. In the POS terminal 102, the CFD assembly 112 is communicably coupled to the MFD assembly 110 via a wire, cable, or communication interface, shown as cable 132, extending from the CFD assembly 112, underneath the base assembly 120 of the vertical stand 114, and to the MFD assembly 110 via the cavity or connector route within the vertical stand 114.

In other implementations or configurations, a POS terminal includes one of the panels (e.g., the MFD assembly 110 or the CFD assembly 112), e.g., operating independently, such as a kiosk station. In some other implementations or configurations, the POS terminal can refer to the interconnected panels operating jointly to process a transaction, such as a POS system 10 stationed at a countertop, where processing the transaction may involve interactions between an employee and a client utilizing the respective panels.

In some embodiments, the MFD assembly 110 incorporates the compute module 20, and the CFD assembly 112 is controlled by the compute module 20, such that the compute module 20 controls operation of the entire POS system 10. Accordingly, the MFD assembly 110 may function as a panel personal computer (PC). In other embodiments, the MFD assembly 110 and the CFD assembly 112 each include a separate compute module, such that each of the MFD assembly 110 and the CFD assembly 112 can be referred to as a panel PC capable of operating independently. For instance, each of the MFD assembly 110 and the CFD assembly 112 can include or may be a tablet capable of operating independently from other devices.

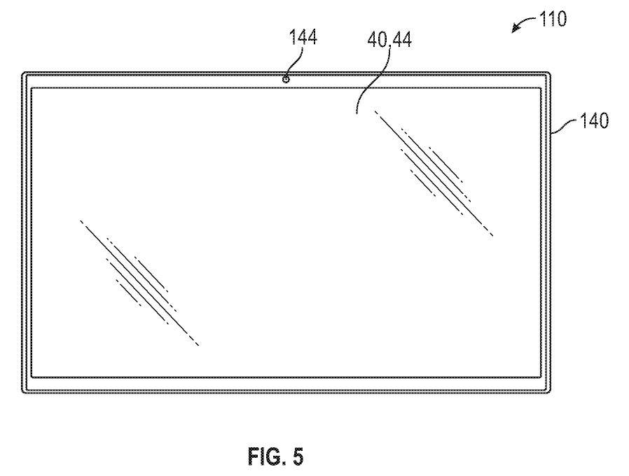

Referring to FIGS. 5–8, the MFD assembly 110 includes a frame, chassis, case, housing, or enclosure, shown as housing 140, that supports and contains the other components of the MFD assembly 110. The housing 140 supports a touchscreen display that serves as both the MFD 40 and the merchant input device 44. The housing 140 includes a bump out, protrusion, or protruding portion, shown as housing expansion 142, that extends outward from a side of the housing 140 opposite the MFD 40. The housing expansion 142 may contain one or more processors coupled with memory, an integrated motherboard, various electrical components, etc. that serve as the compute module 20, such that the MFD 40, the customer input devices 46, and the compute module 20 are contained within the MFD assembly 110. The housing 140 can be disassembled or opened to access hardware components of the respective panel. The compute module 20 may include one or more components that can be replaced, including but not limited to at least one of the central processing unit (CPU), graphics processing unit (GPU), memory, storage, or motherboard.

The MFD assembly 110 further includes an image sensor, shown as camera 144, positioned within the housing 140. The camera 144 may face a similar direction as the MFD 40 and may capture images of the merchant. The camera 144 may be operatively coupled to the compute module 20, such that the camera 144 provides image data to the compute module 20.

The MFD assembly 110 further includes one or more input/output connections, shown as interface ports 146. As shown, the interface ports 146 are positioned along a bottom side of the housing expansion 142. The interface ports 146 can include input/output (I/O) ports for connection with external devices, components, and/or circuits. The interface ports 146 can include, but are not limited to, at least one universal serial bus (USB) port (e.g., type A, type B, or type C), a direct current (DC) jack (e.g., 12V electrical port), a local area network (LAN) port (power over Ethernet (PoE)), at least one display port, at least one high-definition multimedia interface (HDMI) port, or other types of connectivity options. I/O connectors, cables, or wires can be used to connect to the I/O ports, such as for connection or communication between devices. A DC jack can be configured to receive dedicated input power for the MFD assembly 110, which can be used alternately to PoE (e.g., for environments without network power). The USB ports can be configured to receive or transmit data between the MFD assembly 110 and other devices (e.g., the CFD assembly 112, the payment interfaces 52, the extension hub 54, etc.) and may facilitate file transfer, linking devices, supporting video output, supporting power delivery, etc. A LAN port (e.g., Ethernet port) can be configured with PoE capability. The LAN port is configured to permit a cable to deliver data via a network and/or power for powering the respective panel.

As shown in FIG. 7, the housing 140 defines a series of fastener apertures or display mounting apertures, shown as mounting apertures 150. The mounting apertures 150 extend longitudinally into the housing expansion 142 from a rear side of the housing expansion 142 and each define a threaded aperture configured to receive a corresponding male fastener. The mounting apertures 150 may be shaped and/or sized according to the Video Electronics Standards Association (VESA) Mounting Interface Standard (MIS) (e.g., in a 75mm x 75mm square pattern). By utilizing a VESA mounting pattern for the mounting apertures 150, the same mounting apertures 150 may be utilized for mounting the MFD assembly 110 onto a wall, a pole, a pillar, or other structure having a corresponding VESA mounting pattern.

The rear of the housing 140 can include or support a VESA mount compatible with mounting surfaces of various dimensions (e.g., around 75 mm x 75 mm, or other dimensions, such as 65 mm x 65 mm, 70 mm x 70 mm, 80 mm x 80 mm, 90 mm x 90 mm, etc., including surfaces having unequal widths and heights) for mounting the MFD assembly 110 to a mounting structure, e.g., a vertical stand, a wall mount, or other VESA mounts. The compute module 20 can include any type of CPU with suitable performance to support the operations of the POS terminal. The compute module 20 can include any suitable memory configurations, such as DDR4 memory, DDR5 memory, or other configurations. The compute module 20 can include any suitable storage configurations, such as a solid state drive (SSD) or a hard disk drive (HDD), for example.

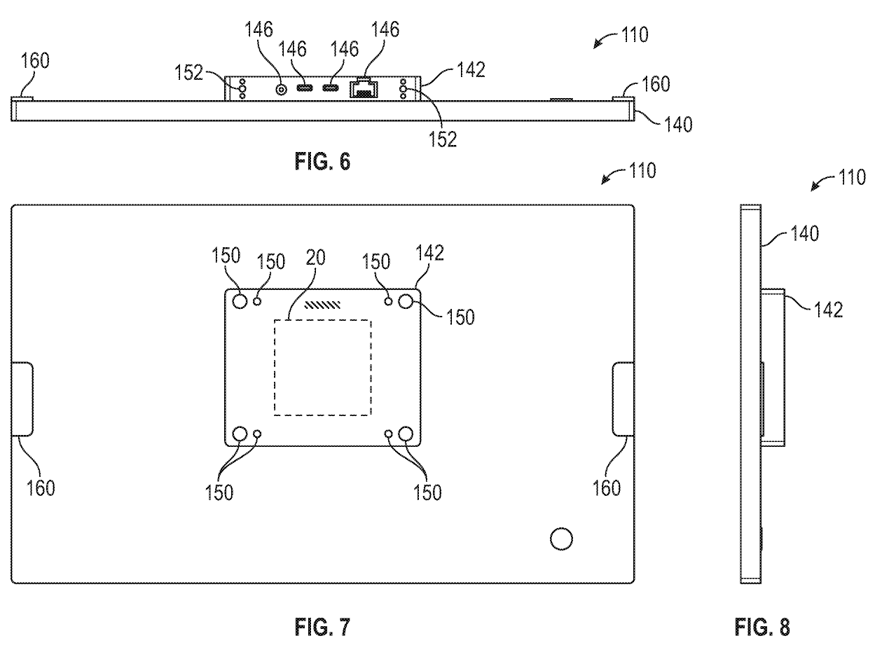

FIG. 5 illustrates a front view of the MFD 40, in accordance with at least one embodiment. The MFD 40 can be a part of a panel (e.g., the MFD assembly 110). FIG. 6–8 illustrate views of the MFD assembly 110 including the MFD 40, in accordance with at least one embodiment. As shown, the housing 140 has a bezel (in the front view), the camera 144 surrounded or enclosed by the bezel, the housing 140 surrounding the edges of the MFD 40 and encasing the sides and the back of the MFD 40, the interface ports 146 disposed at the back of the MFD assembly 110, and various other components. Additionally or alternatively to touch screen elements of the MFD 40, the bezel can be an interactive bezel, allowing a user to interact with one or more elements around the edges of the MFD 40. The interactive bezel and/or the MFD 40 can be configured to detect or sense one or more inputs from the user (e.g., touch input) and provide feedback according to the input. By way of example, the merchant input devices 44 may include touch sensors on the housing 140. For instance, the input from the user can include navigating through menus, selecting options, adjusting settings, or interacting with various applications displayed around the MFD 40, adjacent to the bezel. In some cases, the bezel and/or the MFD 40 may be integrated with at least one haptic actuator for haptic feedback (e.g., the merchant input devices 44 may include vibratory actuators for haptic feedback). The interactive bezel and/or the MFD 40 may support multi-touch gestures, allowing for other types of interactions such as pinch-to-zoom, swipe, or rotate gestures, to name a few. The interactive bezel may include other functions similar to the display device. Types of interactions via the interactive bezel and/or the MFD 40 may be configurable by the administrator or operator of the POS system 10, for example.

The MFD assembly 110 or components of the MFD assembly 110 can be implemented or constructed in different dimensions to suit various criteria. These dimensions are provided as examples and can vary based on specific design configurations. Other aspects of the MFD assembly 110, such as types of components, performance of the components, hardware and/or software configuration, etc., can be implemented according to the desired configurations for the MFD assembly 110. For example, the MFD assembly 110 can measure between about 300 to about 400 mm in a first dimension (e.g., a width direction) and between about 200 mm to about 250 mm in a second dimension (e.g., a height direction), and between about 10 mm to 20 mm in a third dimension (e.g., a depth direction). As an example, the MFD assembly 110 can measure between about 350 mm to about 375 mm in the first dimension, about 200 mm to about 250 mm in the second dimension, and between about 10 mm to about 30 mm in the third dimension. The MFD 40 can feature an edge-to-edge screen, thereby enhancing the aesthetic appearance of the device. For purposes of providing examples, the screen size can be between about 10 inches to about 30 inches, e.g., about 12 inches to about 18 inches, or about 12 inches to about 15 inches, or other dimensions, with a resolution of, for example, 1920 x 1080 pixels (full HD), or another resolution. The MFD 40 can include a brightness setting of up to 500 nits, e.g., suitable for semi-outdoor use. The bezel dimensions can be between about 2.5 mm to about 10 mm on the panel sides and can be between about 5 mm to about 15 mm on the top and bottom.

In further examples, the MFD assembly 110 can include various integrated features such as a merchant-facing camera (facing the merchant-facing display) with fixed focus, and multiple ports for connectivity. Examples of interface ports 146 can include at least one of USB type-C, LAN/PoE, DC jack, power USB (PUSB), USB type-A (e.g., type-A 2.0 and/or 3.0), or registered jack-11 (RJ11). The MFD assembly 110 can include other I/O ports. The interface ports 146 can facilitate different types of connections and power inputs for communication with the MFD assembly 110. The MFD assembly 110 may be equipped with peripheral interfaces (e.g., the merchant accessories 50) such as pogo connectors, a fingerprint reader, or a magnetic stripe reader (MSR).

For communication, the compute module 20 can support Wi-Fi and/or Bluetooth to provide wireless connectivity. The MFD assembly 110 can include built-in speakers or an audio port or jack for audio output. The MFD assembly 110 can be configured to operate within a prescribed operating temperature ranging from -10°C to +50°C, and the storage temperature range can be from -20°C to +60°C, for example. The MFD 40 can be certified for electromagnetic compatibility (EMC) and Conformité Européenne (CE) and Federal Communications Commission (FCC) class A, low voltage directive (LVD) standards, for example. The MFD assembly 110 can include water and/or dust resistance ratings. The MFD assembly 110 can be rated to operate under certain conditions, such as humidity between 20% to 80%. The MFD assembly 110 can include other features and functionality not limited to those discussed herein.

As shown in FIG. 6, the housing 140 further defines a second set of fastener apertures or accessory mounting apertures, shown as mounting apertures 152. The mounting apertures 152 extend vertically into the housing expansion 142 from a bottom side of the housing expansion 142 and each define a threaded aperture configured to receive a corresponding male fastener. The mounting apertures 152 may facilitate coupling another component of the POS system 10, such as a payment interface 52 or a vertical stand 114 to the housing 140.

Referring to FIG. 7, the housing 140 defines a pair of communication interfaces, attachment points, or accessory connection points, shown as expansion slots 160. Each expansion slot 160 is positioned along a rear side of the housing 140 (e.g., a side of the housing 140 opposite the MFD 40). One expansion slot 160 is positioned along a right edge of the housing 140, and another expansion slot 160 is positioned along a left edge of the housing 140. Each expansion slot 160 is communicably coupled to the compute module 20 (e.g., through a connection within the housing 140). Each expansion slot 160 is configured to selectively couple to one of the merchant accessories 50, such that the expansion slots 160 provide attachment points for removably coupling the merchant accessories 50 to the MFD assembly 110. By placing an expansion slot 160 on each side of the housing 140, a user can select which side of the MFD assembly 110 to place a merchant accessory 50 onto (e.g., to place the merchant accessories 50 into a right-handed or left-handed configuration). Alternatively, both of the expansion slots 160 may be utilized to connect two merchant accessories 50 to the MFD assembly 110 simultaneously.

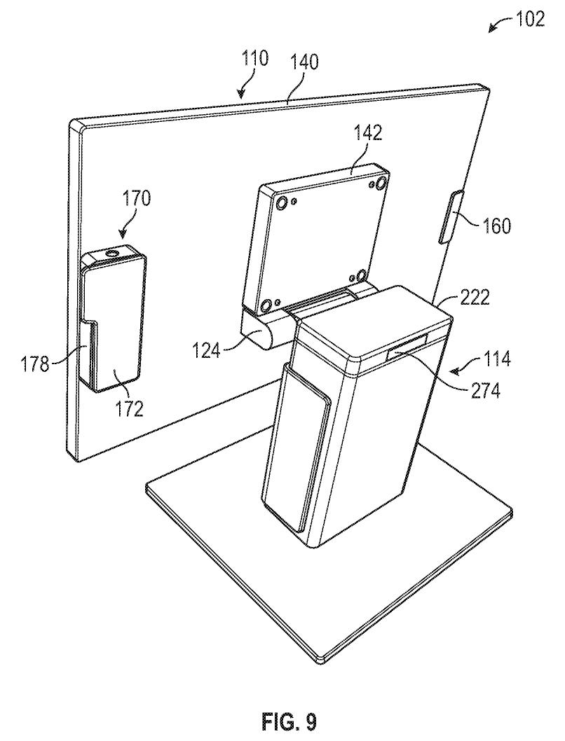

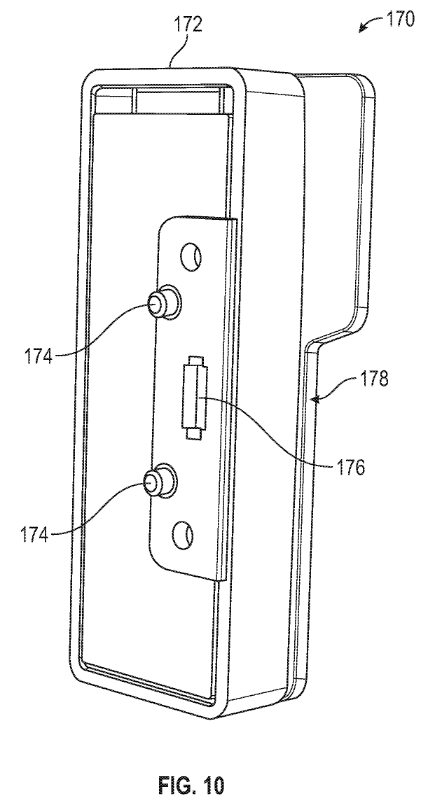

Referring to FIGS. 9 and 10, a first merchant accessory 50 is shown as a magnetic stripe reader (MSR) assembly 170 according to an exemplary embodiment. The MSR assembly 170 includes an enclosure, chassis, frame, or housing, shown as housing 172. The MSR assembly 170 includes a pair of protrusions or mounting pins, shown as locating pins 174, that extend outward from the housing 172. The locating pins 174 are vertically offset from one another and each configured to be received by corresponding apertures of the expansion slot 160 to locate the MSR assembly 170 relative to the housing 140 and limit movement of the MSR assembly 170 relative to the housing 140. The MSR assembly 170 may further be secured to the housing 140 through one or more fasteners. The MSR assembly 170 further includes a connection interface, shown as electrical connector 176, that is positioned between the locating pins 174. The electrical connector 176 is configured to engage a corresponding electrical connector of the expansion slot 160 to place the MSR assembly 170 in communication with the compute module 20.

The housing 172 of the MSR assembly 170 defines a vertical recess, shown as card swiping slot 178. The card swiping slot 178 extends vertically through the MSR assembly 170 and is sized to receive a payment card (e.g., a credit card or debit card). In use, the merchant may swipe a payment card across the card swiping slot 178, and a magnetic stripe sensor within the MSR assembly 170 may read payment details or payment information (e.g., account numbers) from a magnetic stripe on the payment card. The MSR assembly 170 may then transfer these payment details to the compute module 20 for use in completing a transaction. In other embodiments, the MSR assembly 170 is configured to read other data from a magnetic stripe (e.g., user identification information).

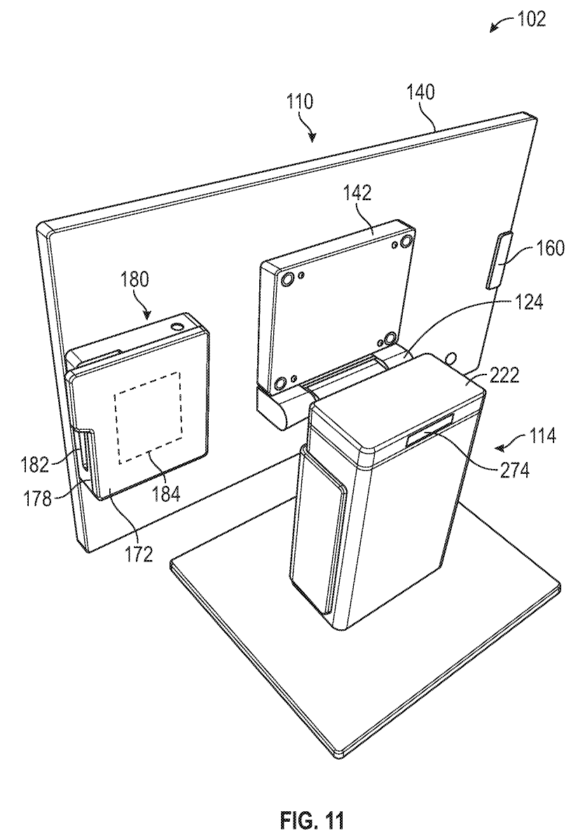

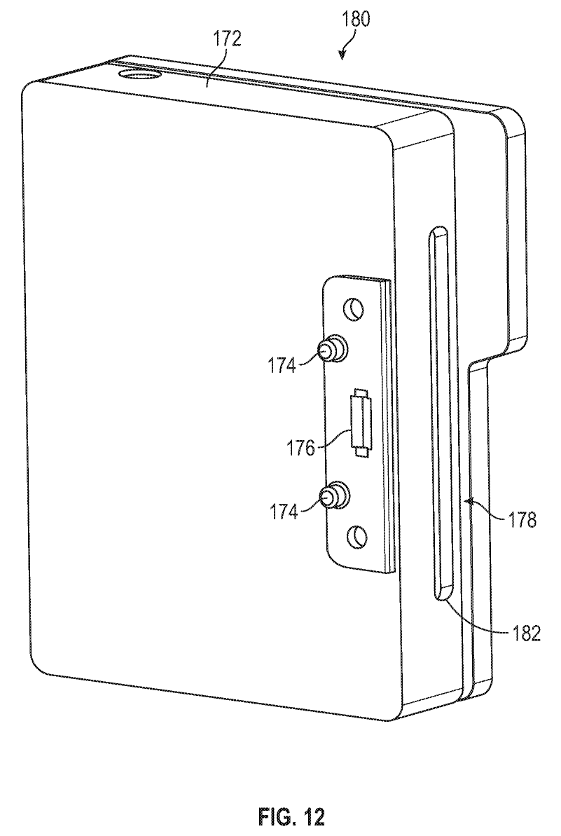

Referring to FIGS. 11 and 12, a second merchant accessory 50 or multi-modal payment interface is shown as payment interface assembly 180 according to an exemplary embodiment. The payment interface assembly 180 includes a housing 172, locating pins 174, an electrical connector 176, and a card swiping slot 178 substantially similar to the MSR assembly 170. Accordingly, the MSR assembly 170 and the payment interface assembly 180 may share a common interface for connecting to the expansion slot 160. The housing 172 of the payment interface assembly 180 may be larger than the housing 172 of the MSR assembly 170 (e.g., to accommodate additional components). In addition to the card swiping slot 178 for reading magnetic stripes, the payment interface assembly 180 further includes additional types of payment interfaces that facilitate other types of communication.

The housing 172 of the payment interface assembly 180 defines a lateral recess, shown as card insertion recess 182. The card insertion recess 182 extends laterally into the payment interface assembly 180 and is sized to receive a payment card (e.g., a credit card or debit card). In use, the merchant may insert a payment card into the card insertion recess 182, and a chip sensor within the payment interface assembly 180 may read payment details (e.g., account numbers) from an electrical contact assembly (e.g., a chip) on the payment card. The payment interface assembly 180 may then transfer these payment details to the compute module 20 for use in completing a transaction. In other embodiments, the payment interface assembly 180 is configured to read other data from a chip (e.g., user identification information).

The payment interface assembly 180 further includes a near-field communication sensor or tap to pay sensor, shown as NFC sensor 184. The NFC sensor 184 may be positioned to communicate with an NFC-enabled payment device (e.g., a payment card or a user device) positioned along a rear side of the payment interface assembly 180. In use, the merchant may place a payment device against the payment interface assembly 180, and the NFC sensor 184 within the payment interface assembly 180 may read payment details (e.g., account numbers) from an NFC-enabled component within the payment device. The payment interface assembly 180 may then transfer these payment details to the compute module 20 for use in completing a transaction. In other embodiments, the payment interface assembly 180 is configured to read other data from an NFC-enabled device (e.g., user identification information).

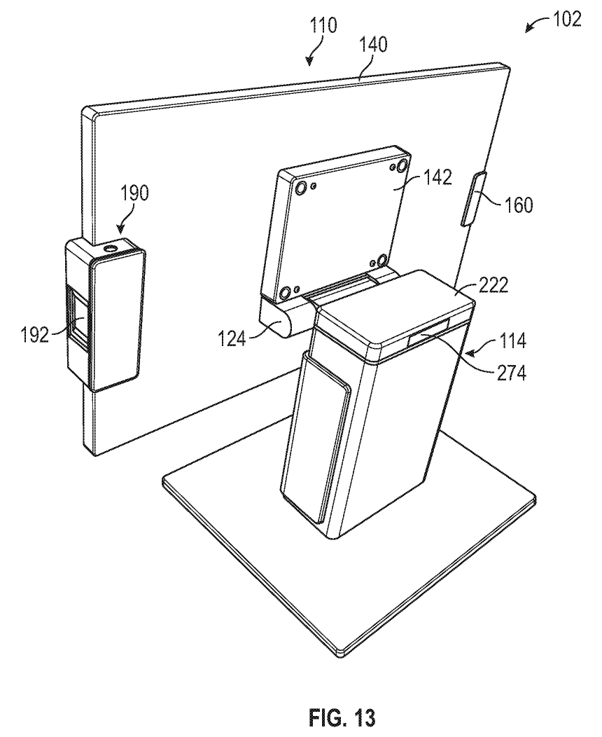

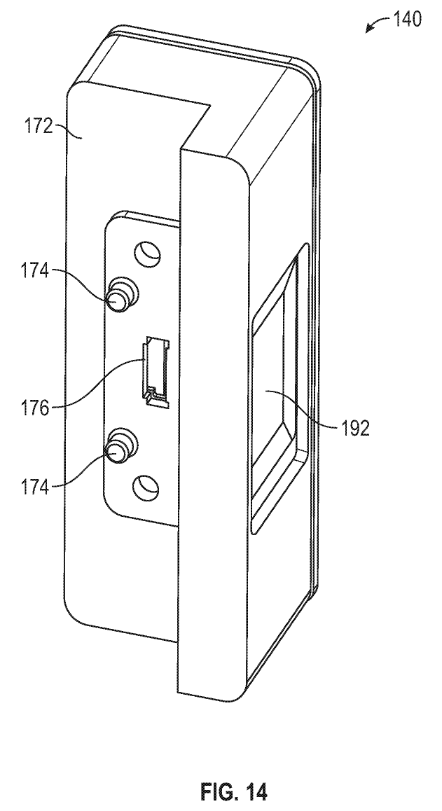

Referring to FIGS. 13 and 14, a third merchant accessory 50 or biometric interface is shown as fingerprint reader 190 according to an exemplary embodiment. The fingerprint reader 190 includes a housing 172, locating pins 174, and an electrical connector 176 substantially similar to the MSR assembly 170. Accordingly, the MSR assembly 170 and the fingerprint reader 190 may share a common interface for connecting to the expansion slot 160. The housing 172 of the fingerprint reader 190 may be differently shaped than the housing 172 of the MSR assembly 170 (e.g., to accommodate placement of the fingerprint sensor 192 in a position along a right or left side of the housing 140).

The fingerprint reader 190 includes a biometric sensor, user identification sensor, or biometric reader, shown as fingerprint sensor 192. The fingerprint sensor 192 is positioned along a side of the housing 172 that faces laterally outward from the housing 140, such that the fingerprint sensor 192 can be accessed by the merchant. The fingerprint sensor 192 is configured to read biometric information, specifically fingerprint data, from a user when the user presses a finger against the fingerprint sensor 192. The fingerprint reader 190 may then transfer the fingerprint data to the compute module 20. The compute module 20 may utilize the fingerprint data to verify the identity of a user (e.g., during a login process for the POS system 10).

The MFD assembly 110 can be constructed to resist various elements or hazards, such as at least one of dust, splash, water, drop, etc. The MFD assembly 110 can support PoE, eliminating or reducing the need for additional power outlets. In some cases, the MFD assembly 110 can support at least 24V USB power or other power output, not limited to 24V USB power. The MFD assembly 110 can include a local storage device (e.g., within the compute module 20) with a suitable capacity, such as 256GB, 512GB, or 1TB. In some configurations, the storage device 30 can be replaced or upgraded with another storage device.

The MFD assembly 110 (e.g., the housing 140 of the MFD assembly 110) can be composed of any suitable materials, such as glass, plastic, or metal. The MFD assembly 110 can include one or more sensors, such as touch sensors, proximity sensors, or light sensors. For example, the MFD assembly 110 can support multi-touch gestures, allowing users to interact with the MFD 40 through taps, swipes, pinches, or other gestures. The MFD assembly 110 can be configured to generate a graphical user interface (GUI) for display to a user. The GUI can include or present configurable information, e.g., images, texts, icons, interactive elements, etc. The MFD assembly 110 can include other features or functionality to present information or interact with the user, for instance, similar to the display of a tablet, smartphone, a television, or a kiosk.

In some cases, the MFD assembly 110 may include more or less components relative to the CFD assembly 112, or vice versa. For instance, the MFD assembly 110 may be mounted directly to a vertical stand 114 and the CFD assembly 112 may not be mounted to a vertical stand 114, or vice versa. The CFD assembly 112 can include a payment interface 52 (e.g., card reader, chip scanner, and/or magstripe reader), while the MFD assembly 110 may instead utilize the merchant accessories 50 to provide a transaction interface. In some configurations, the MFD assembly 110 or the CFD assembly 112 can be near-field communication (NFC)-enabled to support tap-to-pay or communicate with other devices within a predefined proximity of the respective MFD assembly 110 or the CFD assembly 112.

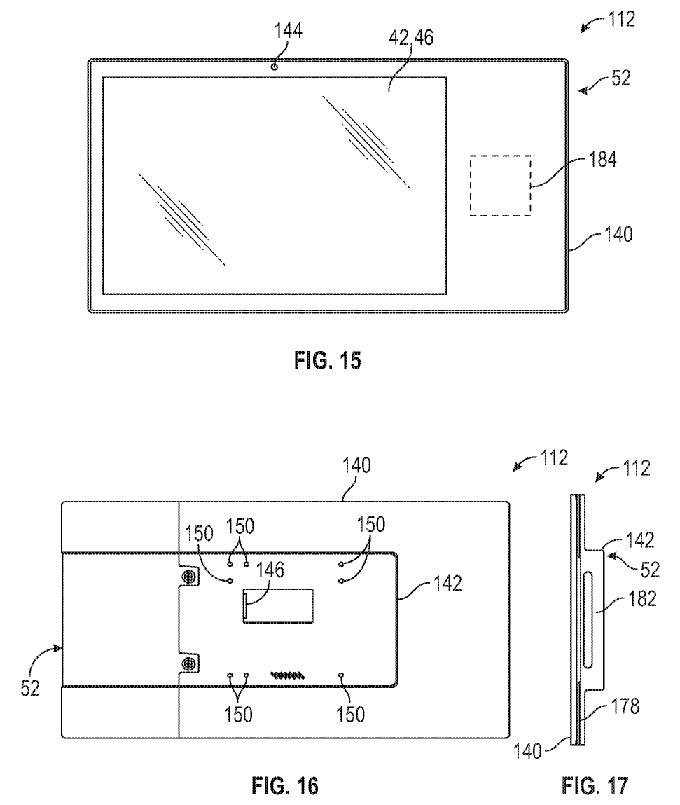

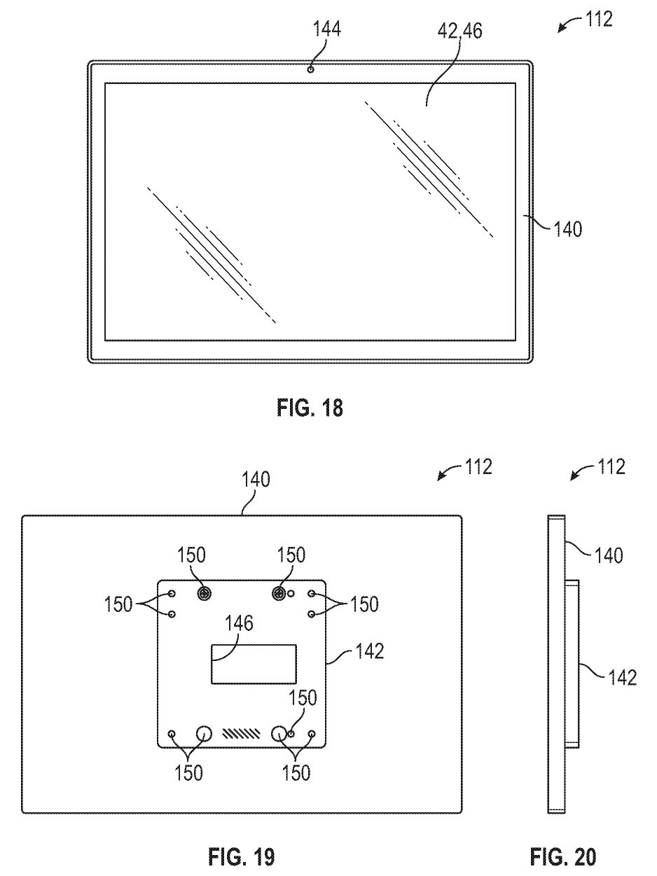

FIGS. 15–20 illustrate various configurations of the CFD assembly 112 for the POS terminal, in accordance with at least one embodiment. FIGS. 15–17 illustrate a configuration of the CFD assembly 112 with a transaction interface (e.g., sometimes referred to as a payment interface), shown as payment interfaces 52. FIGS. 18–20 illustrate a configuration of the CFD assembly 112 without a transaction interface. The CFD assembly 112 may be configured as a standalone device, separate from the MFD assembly 110, or may be controlled by the MFD assembly 110. The transaction interface (e.g., the payment interfaces 52) can refer to one or more components that facilitate payment processing. The transaction interface can include an embedded payment card reader, such as the MOBY5500 (made by Ingenico, Suresnes, France), contactless payment components, chip card readers, and/or magnetic stripe card readers. The transaction interface can include other components to support various payment methods not limited to those discussed herein. In some arrangements, the transaction interface can be mounted flush behind the housing or the display of the CFD assembly 112 to allow for a seamless integration behind the screen surface. By mounting the transaction interface behind the panel, a clean, integrated appearance can be maintained, and potential accidental contact or tampering of the transaction interface can be avoided.

Referring to FIGS. 15–17, the CFD assembly 112 is shown according to an exemplary embodiment. The CFD assembly 112 may be substantially similar in construction to the MFD assembly 110 except as otherwise specified herein. Accordingly, any description of the MFD assembly 110 may apply to the CFD assembly 112, any description of the MFD 40 may apply to the CFD 42, and any description of the merchant input devices 44 may apply to the customer input devices 46, except as otherwise specified herein. The CFD assembly 112 omits the MFD 40 and the merchant input devices 44 and instead includes a CFD 42 and customer input devices 46 positioned within the housing 140. In some embodiments, the MFD 40 is approximately 15.6” (measured diagonally) whereas the CFD 42 is approximately 10.1” (measured diagonally), such that the CFD 42 is smaller than the MFD 40.

The housing 140 for the CFD assembly 112 includes the housing expansion 142, but the compute module 20 is omitted from the CFD assembly 112. The expansion slots 160 are also omitted from the CFD assembly 112. In some embodiments, the CFD assembly 112 includes fewer interface ports 146 than the MFD assembly 110 (e.g., a single USB port that facilitates connecting the CFD assembly 112 to the extension hub 54 or to the MFD assembly 110).

As shown in FIGS. 15–17, the CFD assembly 112 includes the payment interface 52. The payment interface 52 includes a card swiping slot 178, a card insertion recess 182, and an NFC sensor 184 that provide similar functionality for reading payment devices as the payment interface assembly 180. To accommodate the CFD 42, the housing 140 extends laterally beyond the CFD 42 (e.g., such that a bezel of the housing 140 to the right of the CFD 42 is wider than a bezel of the housing 140 to the left of the CFD 42). The housing expansion 142 is expanded to the edge of the housing 140 to provide space for the card swiping slot 178 and the card insertion recess 182. The NFC sensor 184 is positioned within the housing 140 such that the NFC sensor 184 is configured to read a payment device along the front side of the CFD assembly 112.

In some configurations, the payment interface 52 can be embedded as part of the CFD assembly 112. In some cases, the payment interfaces 52 can be a separate component attachable to and detachable from the CFD assembly 112. For instance, as shown in FIG. 16, the transaction interface can be secured or attached to the CFD assembly 112 via screws, mounting brackets, or other mounting mechanisms. The mounting bracket can include multiple screw holes that allow for the payment interfaces 52 to attach to the panel. As shown in the side view in FIG. 17, the payment interfaces 52 can include a card slot for reading the chip when a card is inserted.

Referring to FIGS. 18–20, the CFD assembly 112 is shown according to another exemplary embodiment. The CFD assembly 112 of FIGS. 18–20 may be substantially similar to the CFD assembly 112 of FIGS. 15–17 except as otherwise specified herein. Accordingly, any description of the CFD assembly 112 of FIGS. 15–17 may apply to the CFD assembly 112 of FIGS. 18–20 except as otherwise specified herein.

The CFD assembly 112 of FIGS. 18–20 omits the payment interface 52. By way of example, the CFD assembly 112 of FIGS. 18–20 may be utilized in a POS terminal in which the CFD assembly 112 is equipped with an MSR assembly 170 or a payment interface assembly 180, such that the payment device is handled by the merchant instead of the customer. Due to the omission of the payment interface 52, the housing 140 may be reduced in size relative to the housing 140 of FIGS. 15–17. The CFD assembly 112 of FIGS. 18–20 may be interchangeable with the CFD assembly 112 of FIGS. 15–17 and may be selected based on the required functionality of the POS system 10.

The CFD assembly 112 with the payment interfaces 52 can be wider than the CFD assembly 112 without the payment interface 52, thereby maintaining the dimension of the display device (e.g., the CFD 42). In some configurations, the version of the CFD assembly 112 with the payment interface 52 may include a relatively smaller screen dimension compared to the version of the CFD assembly 112 without the payment interface 52. As an example, the CFD assembly 112 can include a display (e.g., a display between about 8 inches and about 12 inches, such as 10 inches ± 0.5 inches) with a resolution of 1920 x 1200 pixels and a brightness of 500 nits. Other display dimensions, resolutions, and brightness values can be employed. The display of the CFD assembly 112 can support multi-touch with bonded glass. The CFD assembly 112 may be relatively slimmer in depth and lighter in weight without the payment interface 52 compared to the CFD assembly 112 with the payment interface 52. The payment interface 52 can include other types of card readers.

The MFD assembly 110 and the CFD assembly 112 can optionally include at least one camera (e.g., the camera 144). The MFD assembly 110 and the CFD assembly 112 can be compatible with a VESA mount (e.g., 65 mm x 65 mm, 70 mm x 70 mm, 75 mm x 75 mm mount, 80 mm x 80 mm, 85 mm x 85 mm, 100 mm x 100 mm, etc.). The MFD assembly 110 and the CFD assembly 112 can include one or more I/O ports, such as USB ports, supporting alternative display port (DP) for display and/or data connectivity. The MFD assembly 110 and the CFD assembly 112 can be equipped with an internal speaker for audio output. The MFD assembly 110 and the CFD assembly 112 can be certified for dust and water resistance. The MFD assembly 110 and the CFD assembly 112 may include an operating temperature ranging around -10°C to 50°C and can be stored between -20°C and 60°C.

In at least one embodiment, power input can be supported through a DC +12V connection, with a maximum power consumption of less than 20W, e.g., 18W, for example. It should be noted that the example specifications or parameters herein are not intended to limit the MFD assembly 110 and the CFD assembly 112 to the described configurations. For instance, the MFD assembly 110 and the CFD assembly 112 can include various other features and components, such as different types of payment interfaces, display sizes, resolutions, touch technologies, mounting options, and/or connectivity ports. The MFD assembly 110 and the CFD assembly 112 can be configured with different or alternative features or functionality. These examples are provided to illustrate possible implementations and should not be construed as restrictive or exhaustive.

The CFD assembly 112 can include relatively smaller dimensions compared to the MFD assembly 110. In some implementations, the CFD assembly 112 may be the same dimension or may include relatively larger dimensions compared to the MFD assembly 110. The MFD assembly 110 and the CFD assembly 112 can be configured or implemented with similar computing power and/or componentry, e.g., a similar CPU or a GPU. Alternatively, one panel can be implemented with relatively more computing power than the other panel, e.g., the MFD assembly 110 can support relatively higher processing power relative to the CFD assembly 112.

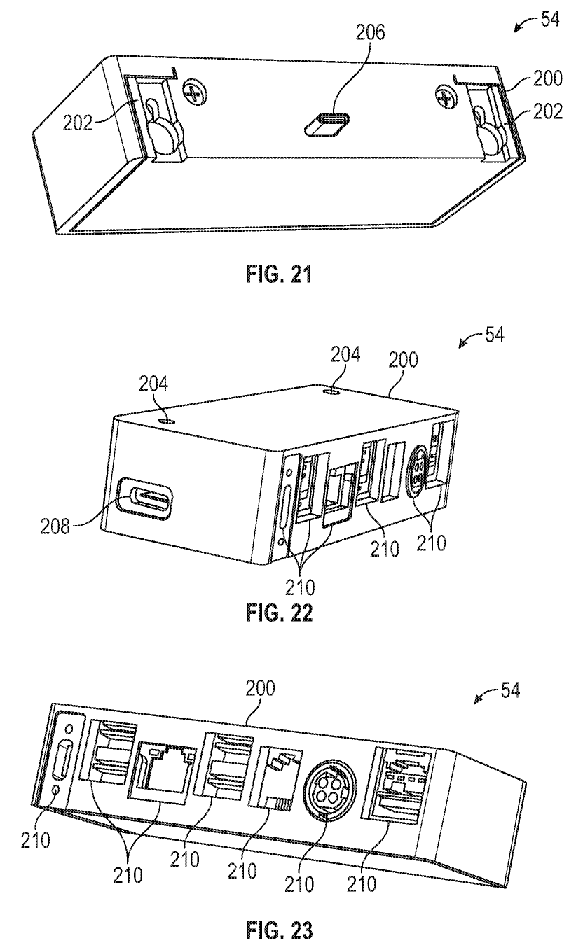

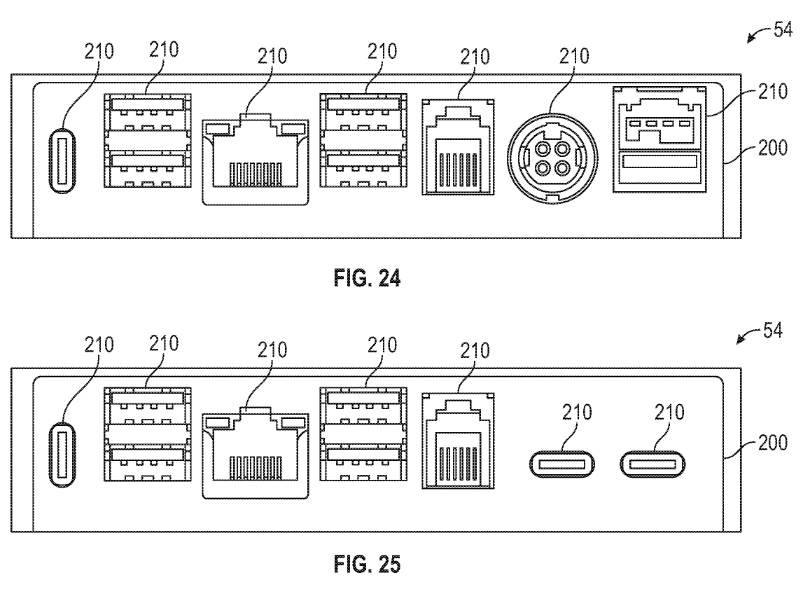

FIGS. 21–25 illustrate the extension hub 54 according to an exemplary embodiment. The extension hub 54 may be coupled to the MFD assembly 110, positioned within the vertical stand 114, or otherwise positioned. Example non-limiting types of I/O ports for the extension hub can be shown in FIGS. 24 and 25. More or fewer I/O ports or alternative types of I/O ports can be provided in the extension hub 54. The extension hub 54 can be rectilinear or possess other shapes incorporating linear and/or curved geometries.

Referring to FIGS. 21 and 22, the extension hub 54 includes a chassis, frame, enclosure, or housing, shown as housing 200. The housing 200 supports the internal components of the extension hub 54 and facilitates coupling the extension hub 54 to other components of the POS system 10. The housing 200 defines a pair of apertures or recesses, shown as mounting bracket recesses 202 that extend into the housing 200 and are laterally offset from one another. The bracket recesses 202 may receive brackets to facilitate coupling the extension hub 54 to the MFD assembly 110. The housing 200 further defines a pair of fastener apertures 204, each configured to receive a fastener to couple the housing 200 to the brackets within the bracket recesses 202.

The extension hub 54 includes a series of ports, connection interfaces, or communication interfaces that facilitate communication between the compute module 20 and the other components of the POS system 10. The extension hub 54 includes a first connection interface, shown as direct compute module connection port 206. The direct compute module connection port 206 is configured to be connected directly to at least one of the interface ports 146 of the MFD assembly 110 when the extension hub 54 is secured to the MFD assembly 110. The direct compute module connection port 206 may operatively couple the MFD assembly 110 to the extension hub 54. In some embodiments, the direct compute module connection port 206 is a male USB-C port. The extension hub 54 includes a second connection interface, shown as indirect compute module interface port 208. The indirect compute module connection port 208 is configured to be connected indirectly to at least one of the interface ports 146 of the MFD assembly 110 (e.g., through a cable) when the extension hub 54 is positioned within the vertical stand 114. The indirect compute module connection port 208 may operatively couple the MFD assembly 110 to the extension hub 54. In some embodiments, the indirect compute module connection port 208 is a female USB-C port.

The extension hub 54 includes a series of third connection ports, shown as expansion ports 210. The expansion ports 210 may be configured to connect to one or more components outside of the MFD assembly 110, such that the one or more components are connected to (e.g., in communication with) the MFD assembly 110 through the extension hub 54. The expansion ports 210 may connect to the CFD assembly 112, to a source of electrical energy (e.g., a wall outlet), or to other components of the POS system 10. The expansion ports 210 may be greater in number and/or variety than the interface ports 146 of the MFD assembly 110, facilitating connecting the MFD assembly 110 to more and/or different components.

FIGS. 24 and 25 illustrate two different configurations of the extension hub 54, each having a different set of expansion ports 210. A user may select between the extension hub 54 of FIG. 24 and the extension hub 54 of FIG. 25 based on the desired functionality of the POS system 10 (e.g., the required port types to connect the desired components of the POS system 10). By way of example, a user may select between the different extension hubs 54 based on the type of power supply available for the POS system 10. In FIG. 24, the expansion ports 210 include a USB Type-C port, two USB-A 2.0 ports, an RJ45 LAN port, two USB-A 3.0 ports, an RJ11 port, a DC jack, and a PUSB 24V port. In FIG. 25, the expansion ports 210 include three USB Type-C ports (e.g., capable of power input), two USB-A 2.0 ports, an RJ45 LAN port, two USB-A 3.0 ports, and an RJ11 port.

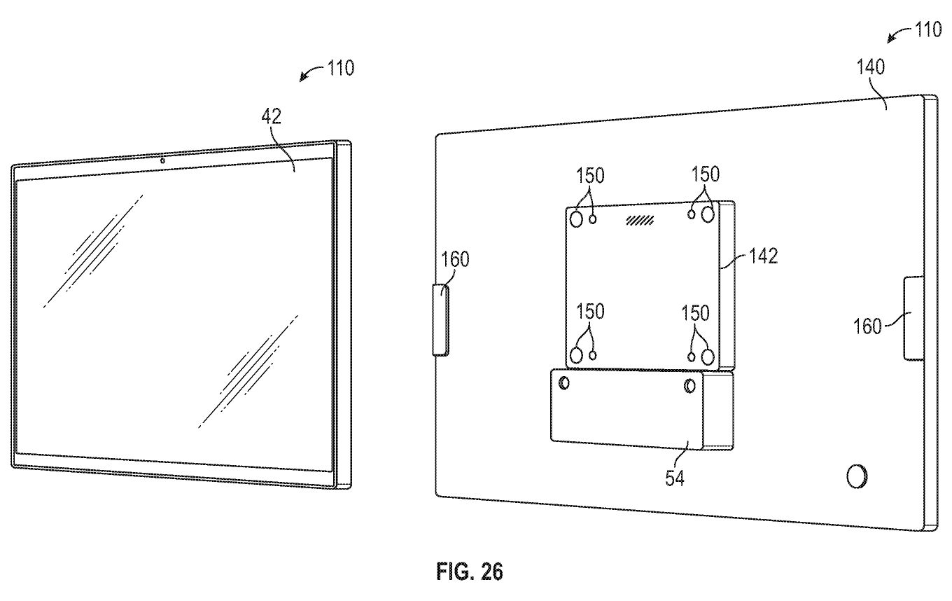

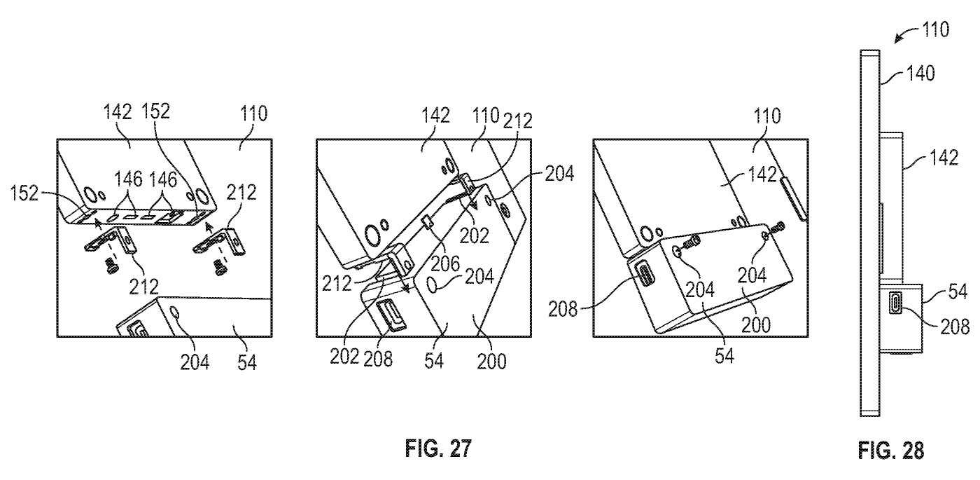

FIGS. 26 and 28 illustrate the extension hub 54 implemented on the back of the MFD assembly 110. FIG. 27 illustrates example steps for coupling or attaching the extension hub 54 to the housing expansion 142 of the MFD assembly 110. The extension hub 54 can be constructed in other dimensions based on the design criteria, not limited to the dimensions shown in FIG. 27. For example, to couple the extension hub 54, a first step (i.e., step 1 of FIG. 27) can involve mounting one or more brackets (or clamps), shown as L-shape mounting brackets 212, to the housing expansion 142. In this case, two L-shape brackets 212 can be installed on the housing expansion 142, secured with screws or other fasteners. The L-shape brackets 212 can be aligned with existing screw holes for installing the screws, specifically the mounting apertures 152. The L-shape brackets 212 can be installed at the bottom of the housing expansion 142 (e.g., such that the L-shape brackets 212 engage a bottom surface of the housing expansion 142). In some configurations, the L-shape brackets 212 can be installed on other sides of the housing expansion 142.

As shown in FIG. 27, one side (e.g., leg) of each L-shape bracket 212 can be secured (e.g., flushed) to the housing expansion 142, while the other side of each L-shape bracket 212 can be extended from the housing expansion 142. The extension hub 54 can include cavities aligned with the L-shape brackets 212. Specifically, one leg of each L-shape bracket 212 is aligned with each bracket recess 202. Step 2 of FIG. 27 can involve sliding the extension hub 54 towards the housing expansion 142, such that the other side of each L-shape bracket 212 is inserted into the cavities (e.g., receivers, receiving slots or recesses) of the extension hub 54 (i.e., the bracket recesses 202). When attaching the extension hub 54 to the housing expansion 142, this step can involve connecting at least one I/O connector (e.g., USB-C) protruding from the extension hub 54 to the corresponding I/O port on the housing expansion 142.

Specifically, the direct compute module connection port 206 may be positioned to engage one of the interface ports 146 to connect the extension hub 54 with the compute module 20. Various suitable types of I/O connectors and I/O ports can be implemented. With the housing expansion 142 and the extension hub 54 adjacent to each other (and the L-shape brackets 212 inserted into the bracket recesses 202 of the extension hub 54), screws or other fasteners can be used to secure the extension hub 54 to the housing expansion 142, as part of Step 3 of FIG. 27 for installing the extension hub 54. Specifically, screws are inserted through the fastener apertures 204 and into the L-shape brackets 212. In some configurations, the extension hub 54 can be coupled to the housing expansion 142 via a magnetic interface. Other types of fasteners and attachments can be utilized for coupling the extension hub 54 on the MFD assembly 110.

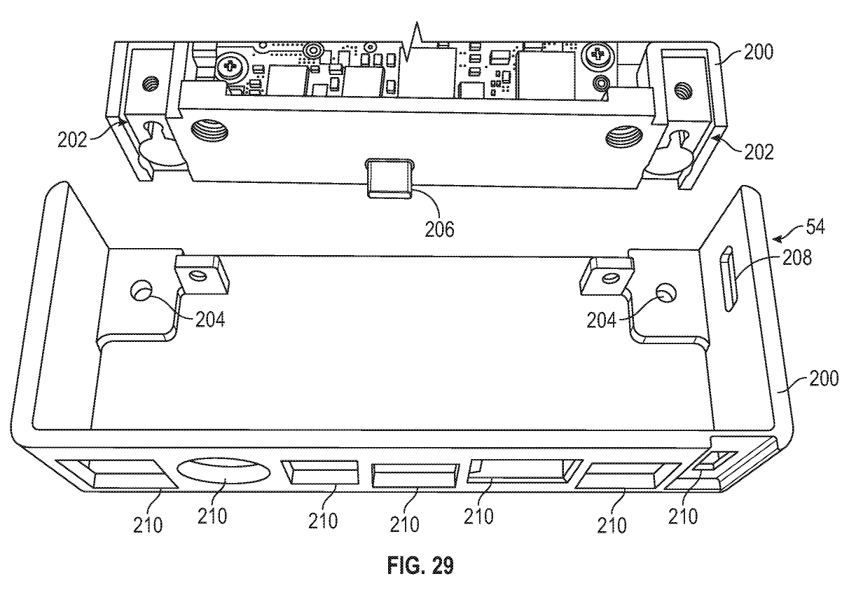

FIG. 29 illustrates example USB-C port fitment and port cutouts for the housing 200 of the extension hub 54, in accordance with at least one embodiment. In certain structures, shell/wall thickness, e.g., for the port cutouts, may interfere with cable insertion and removal, obstructing port access and usability. In various implementations, the wall thickness can be optimized to avoid obstruction at connection ports. Additionally, in certain structures, angled USB-C cables may fail to click securely into place, leading to an unstable connection, which can result in the cables disconnecting from the ports. Thus, according to at least one embodiment, in some configurations, the depth of the USB-C port cutout can be increased to ensure proper seating and enhance tactile feedback, thereby improving overall reliability and user experience when inserting the cable.

In certain structures, the orientation of the latch for certain connectors (e.g., a registered-jack 8-pin connector (RJ45)) can be facing inward, which can complicate the release of the cable during servicing. For ease of use, in at least one embodiment, the latch can be oriented outward to improve the unplugging process during servicing, thereby streamlining maintenance tasks. Other orientations can be implemented, not limited to those discussed herein, to provide additional ease in inserting and/or removing the cables, for example.

For certain port cutouts, tight tolerances around the ports may increase the risk of unintended disconnections and hinder usability. In such cases, expanding or adjusting the position of the cutouts can improve the alignment and ensure suitable clearance to mitigate or minimize the risk of unintended disconnections, while improving usability, for example. In the case of USB-C retention screws of the CFD, relocating the retention screws to a relatively lower position/elevation can enhance access and tool clearance during assembly or field servicing, thereby improving serviceability.

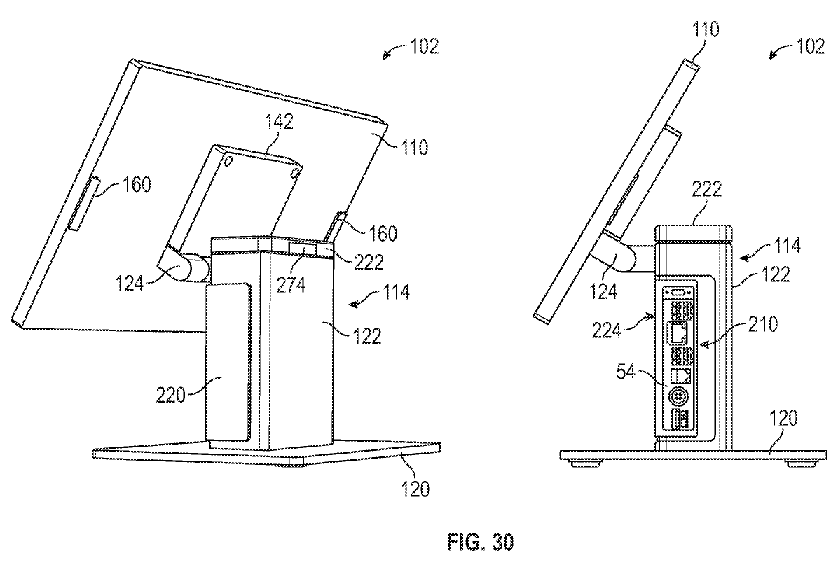

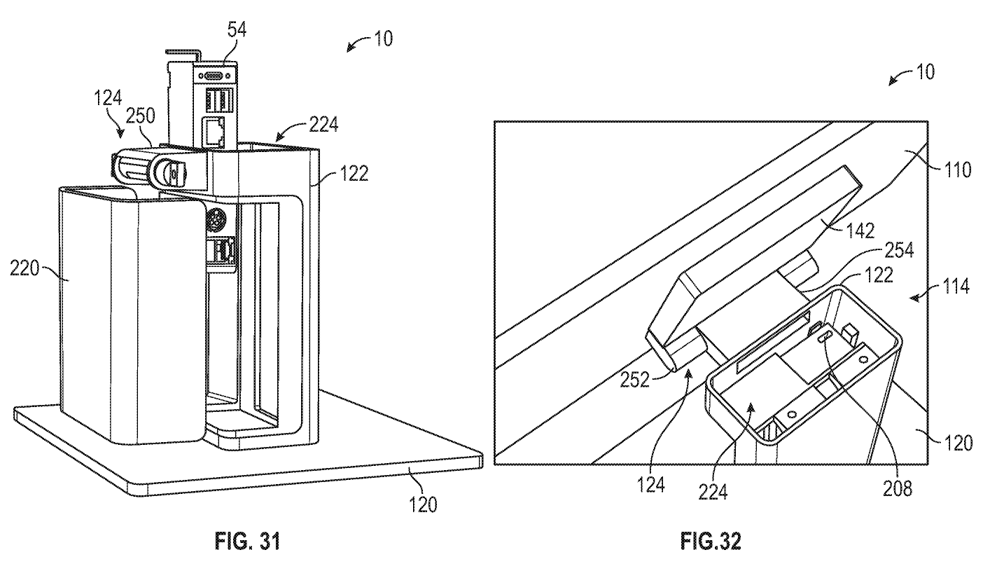

FIG. 30 illustrates the extension hub 54 implemented in the vertical stand 114 (e.g., mounting structure). FIGS. 31 and 32 illustrate a process of installing the extension hub 54 into the vertical stand 114. As shown, the vertical stand 114 can be hollow or include a cavity for routing cables and/or to install the extension hub 54. The vertical stand 114 can include a removable shroud, shield, or cover, shown as cable cover 220, to prevent visibility of or to hide the cable(s) routed through the vertical stand 114. As shown, the cable cover 220 is C-shaped and selectively couples to the support column 122. By way of example, the cable cover 220 may include a series of magnets that magnetically attract to corresponding magnets or a ferrous portion of the support column 122 to removably couple the cable cover 220 to the support column 122.

As shown in FIGS. 30–34, the vertical stand 114 can include a removable top, cover, cap, shield, spacer, or shroud, shown as top 222, coupled to a top end portion of the support column 122. FIG. 30 shows the top 222 installed on the vertical stand 114 and FIGS. 31–33 show the top 222 removed from the vertical stand 114. Together, the support column 122, the cable cover 220, and the top 222 define an enclosed volume, shown as storage volume 224, within the vertical stand 114. As shown in FIG. 32, the extension hub 54 can be inserted into the storage volume 224 from the top end of the support column 122 when the top 222 is removed. In some cases, the extension hub 54 may be inserted from the side (e.g., a front side) of the vertical stand 114 by removing the cable cover 220, for example. The extension hub 54 can be secured in the vertical stand 114 using at least one suitable fastening or coupling mechanism.

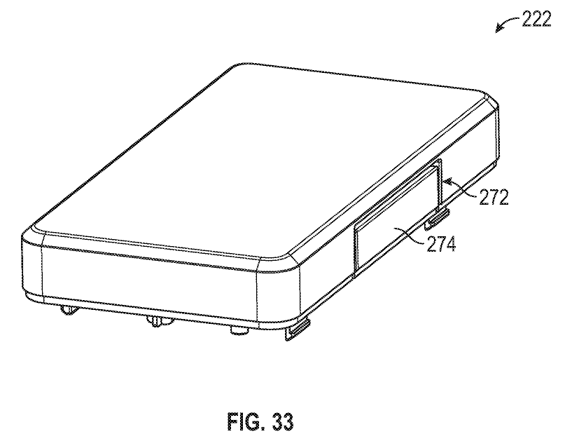

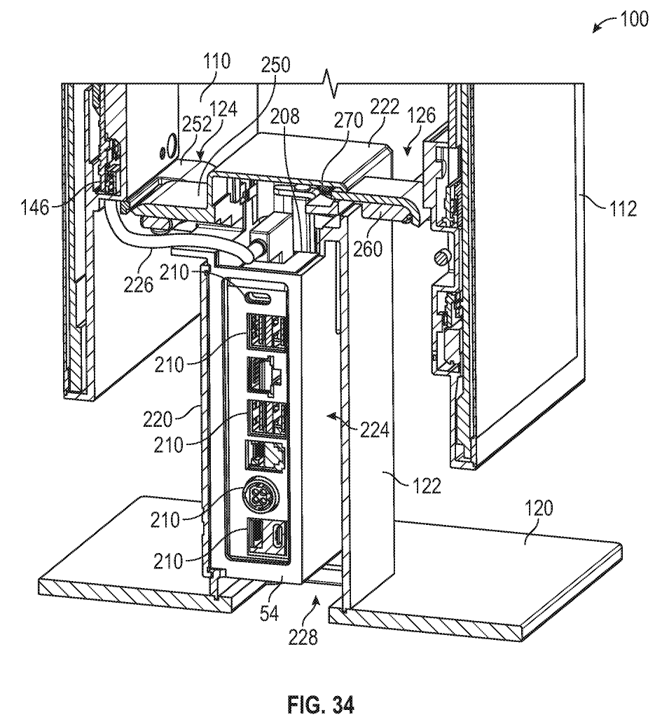

As shown in FIG. 32, visible through the top of the vertical stand 114 with the top 222 removed, the extension hub 54 can include an I/O port (e.g., USB-C in this case), shown as the indirect compute module connection port 208, at the top of the extension hub 54. Other I/O ports (e.g., the direct compute module connection port 206 and the expansion ports 210) can be positioned on the side of the extension hub 54, such as shown in FIG. 29 and when the cable cover 220 is removed, as shown in FIG. 31. A connector or a cable, shown in FIG. 34 as cable 226, can connect to the interface ports 146 of the MFD assembly 110, extend through a cavity or an opening of the attachment point 124, and to the top I/O port of the extension hub 54 (e.g., the indirect compute module connection port 208), thereby allowing electrical coupling between the MFD assembly 110 and the extension hub 54. One or more cables can be routed from the bottom of the vertical stand 114 to plug in one or more I/O ports of the extension hub 54 (e.g., the expansion ports 210). For instance, the vertical stand 114 can include an opening or a path, shown in FIG. 33 as cable routing aperture 228, defined by the base assembly 120 and connected to the storage volume 224 between the support column 122 and the base assembly 120 (e.g., at the coupling point), allowing cables to be routed under the base assembly 120 to the I/O ports (e.g., the expansion ports 210) of the extension hub 54. One or more cables can be routed out of the side of the vertical stand 114 (when the cable cover 220 is removed). In some configurations, cables can be routed from the top of the vertical stand 114 to the one or more I/O ports of the extension hub 54.

In some configurations, the extension hub 54 can be mounted away from the POS terminal. For instance, the extension hub 54 can be mounted under a counter or desk. In this example, a cable can be routed from under the counter, through the vertical stand 114 from under the base assembly 120 (e.g., through the cable routing aperture 228), and to the MFD assembly 110 to establish a connection.

The extension hub 54 can offer additional or alternative I/O ports from the interface ports 146 of the MFD assembly 110. Examples of the extension hub 54 I/O ports can include, but are not limited to, at least one of one or more USB ports, a PoE LAN, power jack, or audio jack. In some cases, the extension hub 54 can include similar I/O ports as the interface ports 146 or different I/O ports from the interface ports 146.

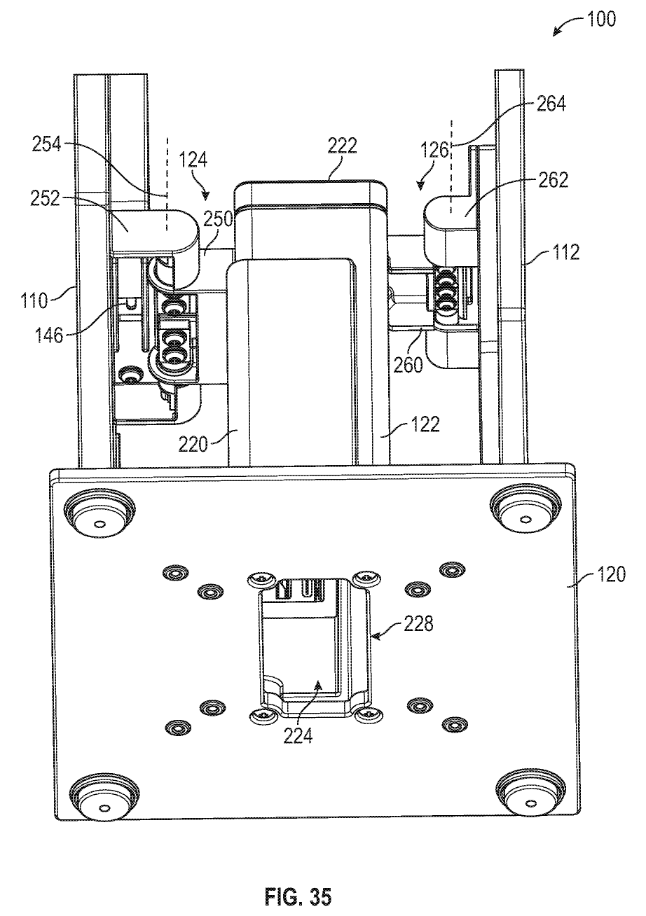

Referring to FIGS. 34 and 35, the attachment point 124 is shown according to an exemplary embodiment. The attachment point 124 includes a first portion or fixed portion, shown as stand portion 250, and a second portion or rotating portion, shown as display portion 252. The stand portion 250 is fixedly coupled to the support column 122. In some embodiments, the stand portion 250 and the support column 122 are integrally formed as a single, continuous piece. The display portion 252 is removably coupled to the housing 140 of the MFD assembly 110. By way of example, a set of fasteners may be inserted through the display portion 252 and engaged with the mounting apertures 152 on the bottom surface of the housing expansion 142. The display portion 252 is pivotably coupled to the stand portion 250, such that the display portion 252 is rotatable relative to the stand portion 250 about a lateral axis of rotation, shown as axis 254. By permitting relative rotation of the display portion 252 and the stand portion 250, the orientation of the MFD assembly 110 may be adjusted to suit a particular viewer. As shown in FIG. 34, the stand portion 250 may define a passage to permit the cable 226 to pass to the MFD assembly 110 from the extension hub 54.

Referring to FIGS. 34–36, the attachment point 126 is shown according to an exemplary embodiment. The attachment point 126 includes a first portion or base portion, shown as stand portion 260, and a second portion or rotating portion, shown as display portion 262. The display portion 262 is removably coupled to the housing 140 of the CFD assembly 112. By way of example, a set of fasteners may be inserted through the display portion 262 and engaged with the mounting apertures 150 on the rear surface of the housing expansion 142. The display portion 262 is pivotably coupled to the stand portion 260, such that the display portion 262 is rotatable relative to the stand portion 260 about a lateral axis of rotation, shown as axis 264. By permitting relative rotation of the display portion 262 and the stand portion 260, the orientation of the CFD assembly 112 may be adjusted to suit a particular viewer.

The stand portion 260 is removably coupled to the support column 122. By making the stand portion 260 removable, the attachment point 126 may be attached or removed from the support column 122 to reconfigure the POS system 10 between the POS terminal 100 and the POS terminal 102. To removably couple the stand portion 260 to the support column 122, a pair of fasteners, shown as thumbscrews 270, extend through the stand portion 260 and into corresponding threaded apertures defined by the support column 122. In some embodiments, the thumbscrews 270 are removable without the use of tools to facilitate reconfigurability of the POS system 10.

Referring to FIGS. 33, 34 and 36, the top 222 covers a portion of the stand portion 260 and the thumbscrews 270 when the vertical stand 114 includes the attachment point 126. To provide clearance for the stand portion 260 to pass through the top 222, the top 222 defines a slot 272 that faces toward the support column 122. Together, the slot 272 and a top surface of the support column 122 define an aperture or passage that the stand portion 260 passes through. In a configuration that omits the attachment point 126, a plug, shield, or cover, shown as blank 274, extends across the slot 272 to fill the space that would otherwise be occupied by the attachment point 126. In some embodiments, the blank 274 is formed as a single, continuous piece with the rest of the top 222 and broken off by a user when the attachment point 126 is installed.

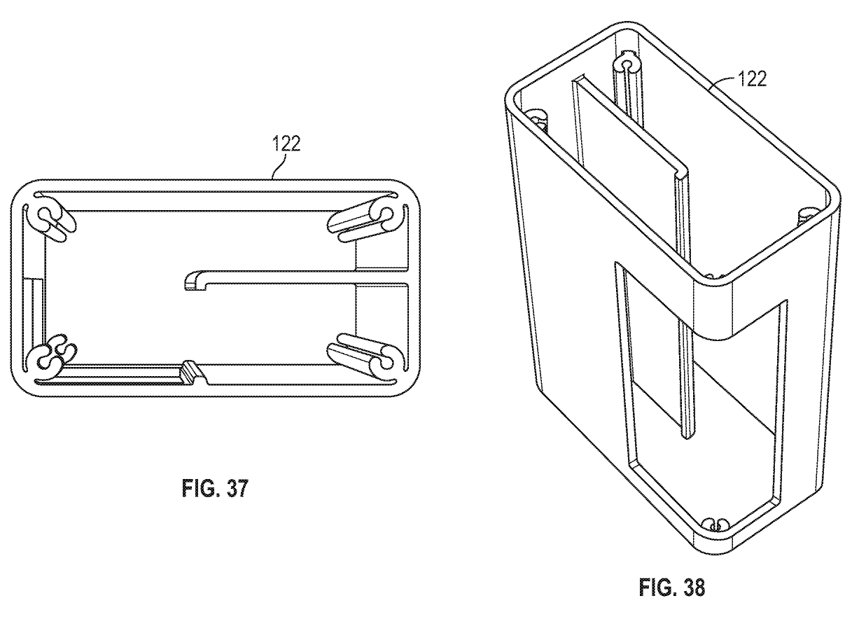

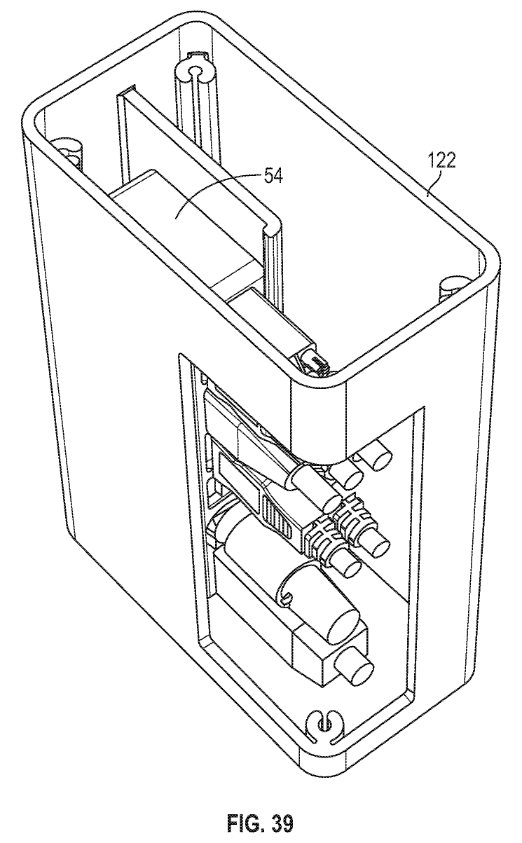

FIGS. 37–39 illustrate views of a pillar for the vertical stand 114. The pillar can refer to the support column 122, extending vertically from the base assembly 120. The pillar of the vertical stand 114 can be configured or structured to allow for routing or organizing one or more cables, or mounting one or more hardware components (e.g., a hub or other devices), among others. It is noted that in certain arrangements, a relatively bulky/large ferrite core or a relatively thick cylindrical ferrite core (e.g., around the DC jack) may be utilized for an I/O connection within the pillar of a vertical stand 114, which may cause a relatively tight fit, limiting cable flexibility, maneuverability, and accessibility. Exemplary embodiments of a POS terminal according to the present disclosure can ameliorate these concerns.

Further, in certain structures, the space available within the vertical stand 114 may be relatively restricted, offering minimal room for efficiently routing cables, e.g., may further be restricted with larger or multiple connectors. Because of the relatively large cable(s) and restriction in the space available within the vertical stand 114, it may be difficult to access the cable(s) (e.g., plugging or unplugging the cable(s)) and maintain organization of the cable(s) within the vertical stand 114, which may result in unsightly clutter from unorganized cables. Here too, the present disclosure sets forth embodiments with a streamlined and uncluttered appearance.

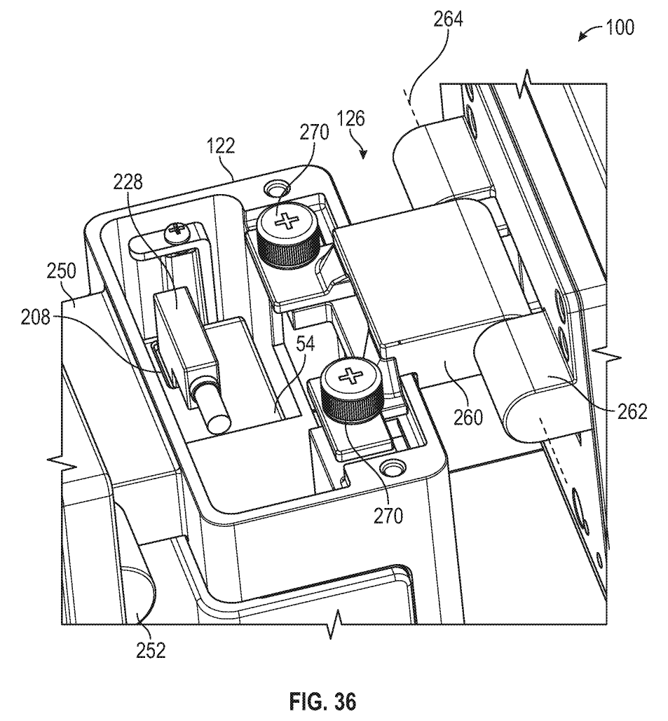

The structure and configuration of the pillar, as described in conjunction with at least FIGS. 36–39, can facilitate efficient accessibility to various ports, cables, connections, or components within the pillar, for instance, by minimizing connector size and optimizing cable routing. Minimizing the connector size and optimizing cable routing can provide for a relatively streamlined aesthetic appearance, functional access, and serviceability (e.g., enhanced ability to service or access components within the vertical stand 114).

For example, in at least one embodiment, a transformer can be integrated into the vertical stand 114 or the pillar. In some cases, an existing DC converter can be replaced with a relatively more compact DC converter or device to reduce bulk and enhance port accessibility. In some implementations, relatively thinner DC jack connectors can be designed, implemented, or utilized to eliminate or bypass the ferrite core bulk and ensure port accessibility. The length of the cables can be customized or tailored to installation criteria, such as dimension of the pillar, length from one I/O port to another, etc. Right-angle connectors, such as USB-A, USB-C, and DC power, can be implemented for improved fitting within the available space of the pillar. In some configurations, extruded stand designs can be leveraged or provided to increase available internal routing space, for example.

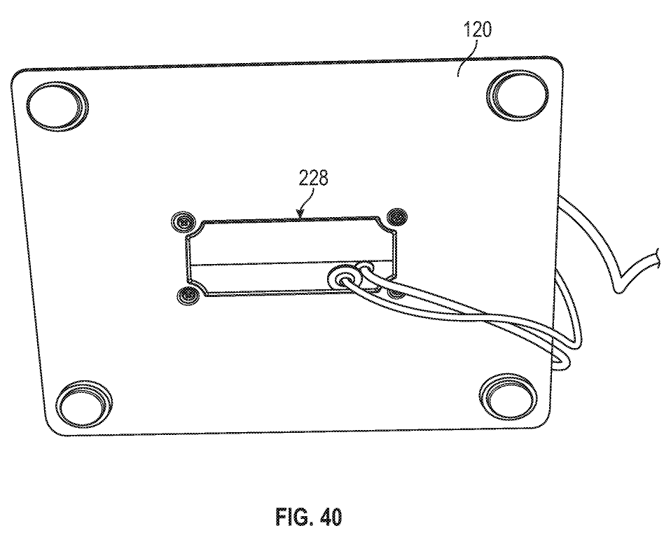

In at least one embodiment, standardization in cable parameters or design can be achieved, for instance, by setting consistent (e.g., standard) cable lengths to facilitate efficient field deployment and ensure service can be performed as desired. In some cases, internal cable routing channels can be added or increased for cable management and organization. The number of cables allowed within the pillar or types of configurations for the cables, e.g., lengths, connection types, size, or cable bend, etc., can be specified. The cables can be configured for serviceability and visual cleanliness, etc. In some other cases, under-base channels can be implemented for routing exits and strain relief, e.g., as described in conjunction with at least FIG. 40.

In at least one embodiment, the pillar can be structured for manufacturability or efficiency in constructing, assembling, or forming the pillar for the vertical stand 114. For example, a die-cast pillar can be structured to be extruded in aluminum with lower manufacturing resource consumption, e.g., reduced materials for constructing the pillar. Machining or 3D-laser technology can be utilized after the extrusion for etching, polishing, or removing excess materials during the formation of the pillar. The connection to the base plate and hinge can be structured for alignment or compatibility with the pillar. The connection to the base plate can be fastened or coupled to the towers as a part of the extrusion, using one or more coupling mechanisms such as screws, magnets, etc. The extrusion method can allow the stand to be cut to desired sizes for installation or system integration, enabling user-specific tailoring.

A cable can be routed under the terminal in any direction. The base assembly 120 of the vertical stand 114 can be elevated (from a surface) via the footing of the vertical stand 114. As an example, the base plate 120 can be elevated from a surface (a base surface, a tabletop surface, a counter surface, etc.) by about 5 mm to about 20 mm, including about 6 mm, about 7 mm, about 8 mm, about 9 mm, about 10 mm, about 11 mm, about 12 mm, about 13 mm, about 14 mm, about 15 mm, etc. The base plate 120 may be elevated higher or lower depending on configuration criteria (e.g., by varying the size of feet connecting the base assembly 120 to a ground surface).

FIG. 40 illustrates a bottom view of a base plate 120 (or mounting plate), in accordance with at least one embodiment. In some cases, a countertop mounting plate featuring a screw pack/kit and threaded hole support can be implemented. As shown, the base plate 120 of the POS terminal can include at least one opening or cavity to allow for cable bypass, shown as the cable routing aperture 228. The base plate 120 can be coupled to the support column 122 of the POS terminal using the screw pack. In some implementations, the vertical stand 114 can include a C-shaped mounting plate. The C-shaped mounting plate can facilitate the unit sliding into position even with cables that are pre-installed, thereby enhancing installation flexibility without removal of the cables. The C-shaped mounting plate can streamline the mounting process, facilitating the setup of the POS terminal. In some configurations, the screw kit can include variable lengths to accommodate for different counter thicknesses, ensuring adaptability across a range of installation environments. The mounting plate can include other components for facilitating the mounting process, such as feet for the mounting plate or cable management accessories, among others.

The structures or components of the POS terminal can be finished using at least one suitable coating or anodizing technique. For example, surfaces of one or more components of the POS terminal, such as the support column 122 or the base plate 120, can be anodized or powder-coated for relatively durable finishes, including a relatively high resistance to scratches, fingerprints, or long-term wear. The resulting surface can be easily cleaned. Other suitable paint or coating techniques may be utilized in the finishing process.

In some implementations, different types of stand covers or cable cover 220 can be implemented for the POS terminal. For example, magnetic plates can be replaced with friction-fit mechanisms, e.g., with grommeted interfaces, to allow for a relatively easier and more secure installation. The stand cover can be configured to address potential tolerance issues with aluminum covers which may lead to scratching and paint or coating wear. For instance, profiles of components of the POS terminal, including deeper routing or a thinner cover, can be considered to prevent accidental removal. In certain implementations, the disengagement mechanism of the cover can be configured for a relatively more deliberate and secure disengagement. The stand cover can avoid metal-on-metal contact to reduce wear over time.

Alternative materials or coatings can be utilized for preventing metal-on-metal contact or minimizing the wear caused by the contact. In some configurations, triangle clips can be used for the top cover to improve fitting and retention. In some cases, replaceable knockout plates can be integrated as part of the stand cover for modularity and service access. For the design of the assembly for the POS terminal, the number of screws or coupling components can be minimized or reduced to enable both design flexibility and assembly efficiency without compromising the aesthetics of the POS terminal. In some cases, toolless construction methods or assembly can be utilized for a relatively faster installation or assembly of the POS terminal, with reduced complexity for user-friendly builds.

In various implementations, a modularized stand can be designed, configured, or implemented for efficiency and simplicity. For example, the modularized stand can include a single cable connection that consolidates or aggregates various pre-configured peripherals into one unit. The modularity of the stand can streamline installation, reduce cable clutter, and enhance usability in various environments, such as, but not limited to, retail and stadiums. The POS terminal, including the modularized vertical stand 114, can include one or more integrated components, such as at least one of a built-in printer, a 2D barcode scanner, an RFID reader supporting high and low frequency applications to cater to diverse operational parameters, a multicolor light bar for visual status feedback, or dual-lane support, facilitated by the integration of a secondary USB hub. The stand can include other integrated components, not limited to those discussed herein.

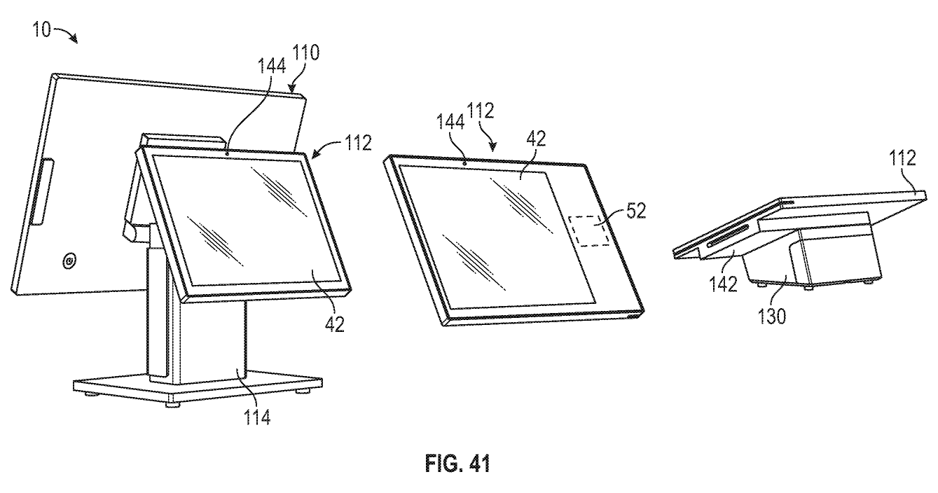

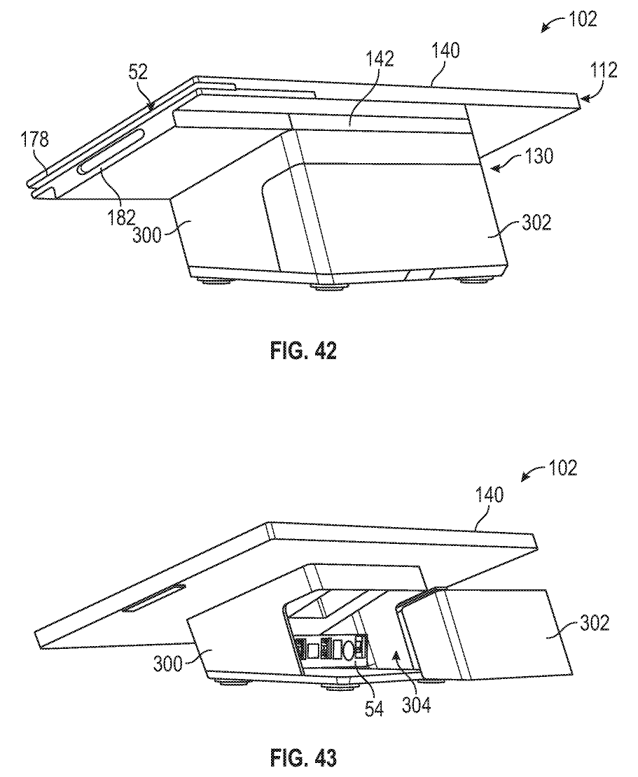

FIGS. 41–45 illustrate views of the CFD assembly 112 with a counter stand for the POS terminal, in accordance with at least one embodiment. As shown in FIG. 41, both the CFD assembly 112 with the payment interface 52 and the CFD assembly 112 without the payment interface 52 are compatible with (e.g., capable of being connected to and supported by) both the vertical stand 114 and the low-profile stand 130. The CFD assembly 112 may be interchangeable between the vertical stand 114 and the low-profile stand 130 as desired for a particular application of the POS system 10. In FIGS. 41 and 42, the CFD assembly 112 with the payment interface 52, e.g., chip card readers, magnetic stripe card readers, near-field communication, etc., is supported by a low-profile stand 130. In FIG. 43, the CFD assembly 112 without the payment interface 52 is supported by a low-profile stand 130. In some configurations of the POS system 10, the MFD assembly 110 is coupled to and supported by a low-profile stand 130 in a similar manner to the CFD assembly 112.

As shown in FIGS. 42 and 43, the low-profile stand 130 includes a housing, chassis, or frame, shown as housing 300, that supports the CFD assembly 112. The housing 300 may be removably coupled to the housing 140 of the CFD assembly 112 by inserting one or more fasteners through the housing 300 and into the mounting apertures 150 on the housing 140. The low-profile stand 130 may include one or more feet positioned on a bottom surface of the housing 300 and engaging a ground surface below the housing 300 to support the housing 300. The feet may space the housing 300 a distance above the ground surface (e.g., to provide clearance for cables).

The low-profile stand 130 can include a removable shroud, shield, or cover, shown as cover 302, to prevent visibility of or hide the cable(s) routed through the low-profile stand 130. As shown, the cover 302 can be arcuate (e.g., having a horseshoe or letter “C” shape) and can selectively couple to the housing 300. By way of example, the cover 302 may include a series of magnets that magnetically attract to corresponding magnets or a ferrous portion of the housing 300 to removably couple the cover 302 to the housing 300.

Together, the housing 300 and the cover 302 define an enclosed volume, shown as storage volume 304, within the low-profile stand 130. As shown in FIG. 43, the extension hub 54 can be inserted into the storage volume 304 from the rear side of the low-profile stand 130 when the cover 302 is removed. In some cases, the extension hub 54 may be inserted from the a top side of the low-profile stand 130 by removing the CFD assembly 112, for example. The extension hub 54 can be secured in the housing 300 using at least one suitable fastening or coupling mechanism.

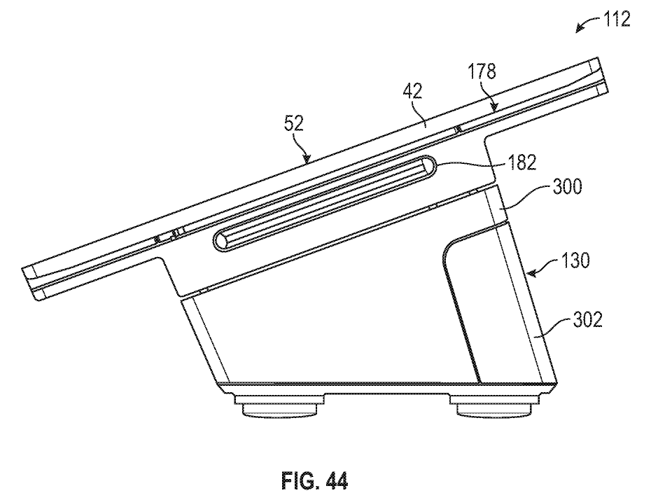

FIG. 44 illustrates a side view of the CFD assembly 112 positioned at a first viewing angle (e.g., by about 55° to about 80°, for example, by about 65°, about 70°, or about 75°, or another angle) on a low-profile stand 130. It should be noted that other viewing angles may be implemented according to the design criteria of the low-profile stand 130. The viewing angle can be implemented to enhance user interaction with the CFD assembly 112, providing a relatively more comfortable and ergonomic setup for the second panel. The low-profile stand 130 can elevate the CFD assembly 112 to the viewing angle.

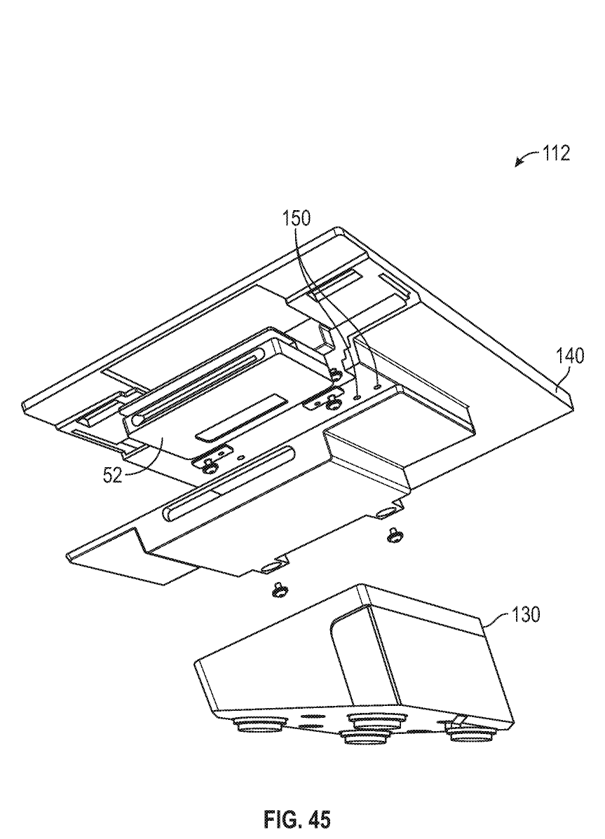

FIG. 45 illustrates an exploded view of the CFD assembly 112 detached from the low-profile stand 130, thereby exposing a payment interface 52 configured as a card reader (e.g., MOBY5500 provided as an example), and other components and assembly parts. The low-profile stand 130 can include a base and an upper section. FIG. 45 also illustrates screws and other parts between the CFD assembly 112 and the low-profile stand 130, showing an example assembly process or means for assembly. For example, the card reader can be secured to the back of the CFD 42. The housing 140 can be attached to the back of the CFD 42, configured for mounting to the base of the low-profile stand 130. Subsequent to attaching the housing 140 to the CFD 42, the CFD assembly 112 can be lowered into or onto the housing 300. One or more suitable coupling or fastening mechanisms can be utilized to secure the upper section (e.g., housing expansion 142 of the CFD assembly 112) to the housing 300, such that the CFD assembly 112 is coupled to the low-profile stand 130. The CFD assembly 112 can be detached from the low-profile stand 130 by reversing the process described above. Other coupling techniques can be utilized, not limited to those described herein.

In some implementations, one or more cables (e.g., the cable 132) can be routed from the bottom of the low-profile stand 130, such as to connect with the MFD assembly 110. The CFD assembly 112 may be considered as a POS terminal (e.g., alone or in combination with the MFD assembly 110). In some cases, the CFD assembly 112 can communicate with the MFD assembly 110 wirelessly.

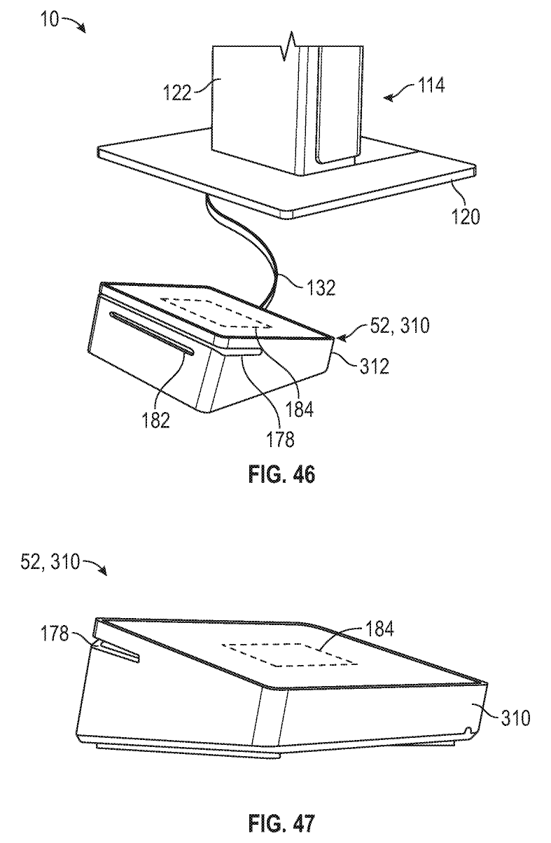

Referring to FIGS. 46 and 47, the POS system 10 is shown to include a dedicated payment interface, payment device, or transaction interface, shown as module 310. The module 310 may serve as a payment interface 52 separate from the CFD assembly 112. The module 310 may be provided in addition to instead of the CFD assembly 112. By way of example, in one configuration of the POS system 10, the CFD assembly 112 is omitted, and the module 310 is the only customer-facing portion of the POS system 10. The module 310 can be provided as a relatively compact interface having a relatively confined footprint, and can be shaped as a puck, disc, trapezoidal block, or other shape.

The module 310 includes a chassis, housing, enclosure, or frame, shown as housing 312. The housing 312 supports and contains a card swiping slot 178, a card insertion recess 182, an NFC sensor 184, and the corresponding electronic components (e.g., sensors) required for the functionality of the module 310. The module 310 may be in wireless communication with the compute module 20 or may communicate with the compute module 20 through a wired connection (e.g., through a cable 132).

FIGS. 3, 4, 26, 30 and 44 illustrate example mounting configurations for components of the POS system 10, in accordance with at least one embodiment. FIG. 30 illustrates an example mounting configuration of one MFD assembly 110 coupled to a vertical stand 114 (e.g., mounting structure) to form a portion of a POS terminal 102. As shown, the POS terminal 102 can include the MFD assembly 110 attached to the vertical stand 114 via an attachment point or an arm extending from the vertical stand 114 (e.g., the attachment point 124). The attachment point 124 can include a joint configured to permit the MFD assembly 110 to rotate about at least one axis, such as a lateral axis for tilting the MFD assembly 110 up or down, a vertical axis for tilting the MFD assembly 110 side to side, or a longitudinal axis to rotate the MFD assembly 110 between portrait and landscape configurations. The attachment point 124 can couple to the side of the support column 122 and the back of the MFD assembly 110 (e.g., including the bottom, side, top, or back of the housing expansion 142). In this case, the attachment point 124 can attach to the bottom of the housing expansion 142.

FIG. 26 illustrates an example mounting configuration of an MFD assembly 110 coupled to a wall through a wall mount. The wall mount can include a VESA bracket. In this case, the VESA bracket for mounting the MFD assembly 110 to the wall can be a mounting structure. In some embodiments, the MFD assembly 110 can comply with VESA Mounting Interface Standard (MIS) D (75/100) for mounting. As an example, the VESA bracket can measure around 75mm x 75mm, although these dimensions are purely illustrative and not limiting, and the dimensions can instead be 65 mm x 65 mm, 70 mm x 70 mm, 80 mm x 80 mm, 85 mm x 85 mm, or other dimensions, including differing dimensions for width and height. The wall mount can include a hub configured to couple with the housing expansion 142 of the MFD assembly 110. In this case, the POS terminal can include or represent the MFD assembly 110 itself, e.g., with or without the wall mount. The MFD assembly 110 can be secured to the mounting structure using any suitable coupling mechanism, fastening mechanism, or accessories. The panel can be detachable from the wall at the VESA bracket.

FIGS. 3 and 4 illustrate an example mounting configuration of two panels (e.g., the MFD assembly 110 and the CFD assembly 112) coupled to the vertical stand 114. Example relative dimensions of various components of the POS terminal 100 can be seen in FIGS. 3 and 4. It should be noted that the illustrated dimensions are not intended to limit the scope of the invention but rather to provide examples of certain configurations or arrangements. As shown, the panels can be attached to the vertical stand 114 via attachment points (e.g., arm or bracket coupling the vertical stand and the panel), shown as attachment point 124 and attachment point 126. For example, the vertical stand 114 can include a first attachment (e.g., the attachment point 124) disposed at a first side of the vertical stand 114 for coupling with the MFD assembly 110 and a second attachment (e.g., the attachment point 126) disposed at a second side, opposite to the first side of the vertical stand 114 for coupling with the CFD assembly 112. The attachment points (e.g., the attachment point 124 and the attachment point 126) can be detachable from any one or more of the vertical stand 114, the MFD assembly 110, and the CFD assembly 112. In some implementations, the one or more attachment points may be integral to at least one of the support column 122, the MFD assembly 110, or the CFD assembly 112. For instance, the attachments can be integrated as part of the vertical stand 114 or integrated as part of at least one of the panels. When mounted, the MFD assembly 110 and the CFD assembly 112 can face in opposite directions from each other.

FIG. 44 illustrates an example mounting configuration of a standalone CFD assembly 112. The CFD assembly 112 can be mounted on a low-profile stand 130 configured to angle the panel by a predefined degree. For example, the counter stand can tilt the panel (e.g., by about 55° to about 80°, for example, by about 65°, about 70°, or about 75°, or another angle) to enhance the viewing angle for user interaction and improve visibility of the display of the panel. In this case, the viewing angle may be fixed. In some configurations, the counter stand may include at least joint (similar to the vertical stand) to allow tilt or rotation of the panel. The POS terminal can be implemented with other non-limiting mounting configurations.

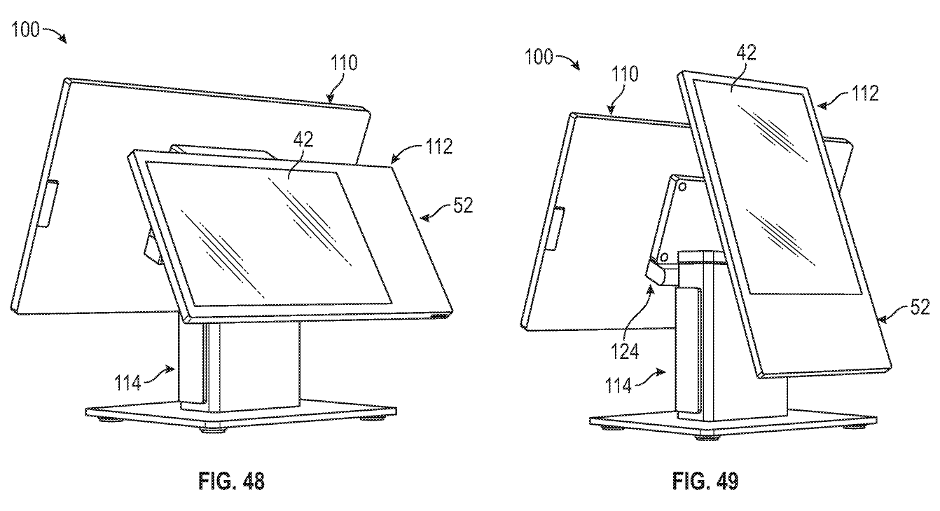

FIGS. 48 and 49 illustrate perspective views of the CFD assembly 112 in different orientations, in accordance with at least one embodiment. As shown, the CFD assembly 112 can be placed in a landscape or horizontal orientation (e.g., shown in FIG. 48) or a vertical or portrait orientation (e.g., shown in FIG. 49). The CFD assembly 112 may be rotated to the desired orientation. In some configurations, the orientation of the CFD assembly 112 is fixed. In other configurations, the attachment point 126 permits rotation of the CFD assembly 112 between the horizontal orientation and the vertical orientation. The MFD assembly 110 may similarly be rotated between horizontal and vertical orientations. The MFD assembly 110 and the CFD assembly 112 may each vary the corresponding GUIs shown on the MFD 40 and the CFD 42 to support different orientations. By supporting different orientations, the CFD assembly 112 can be configured as a kiosk for self-service such as in a vertical orientation and for customer interaction with an employee such as in the landscape orientation, for example.

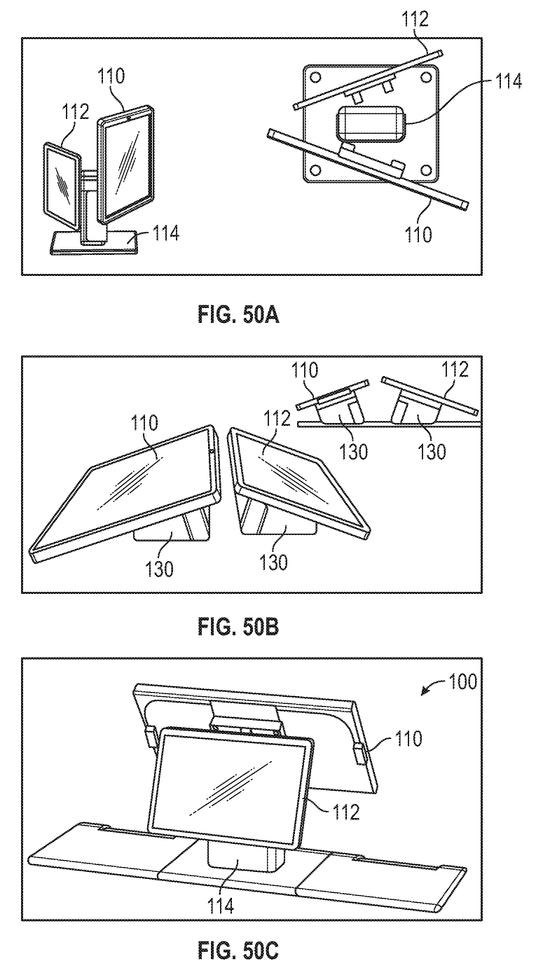

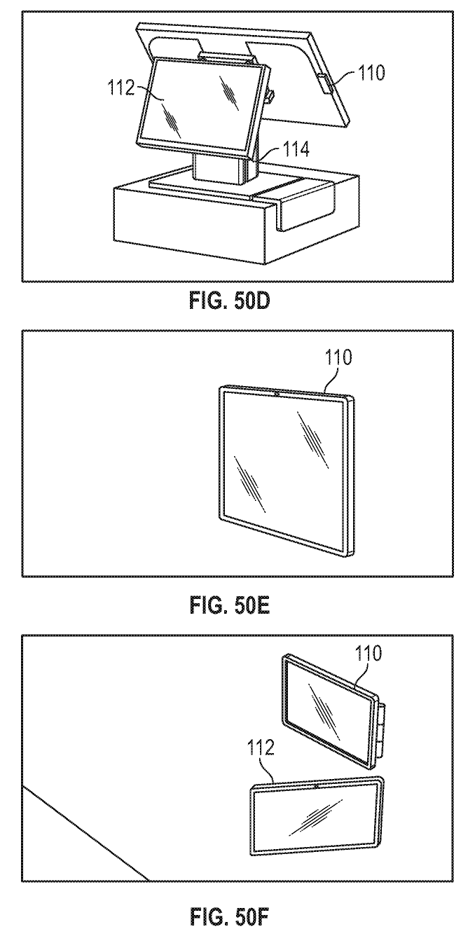

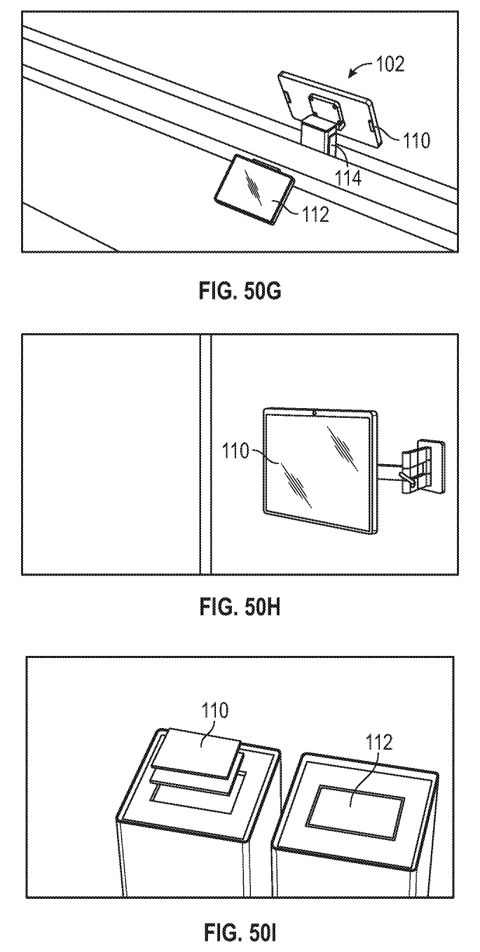

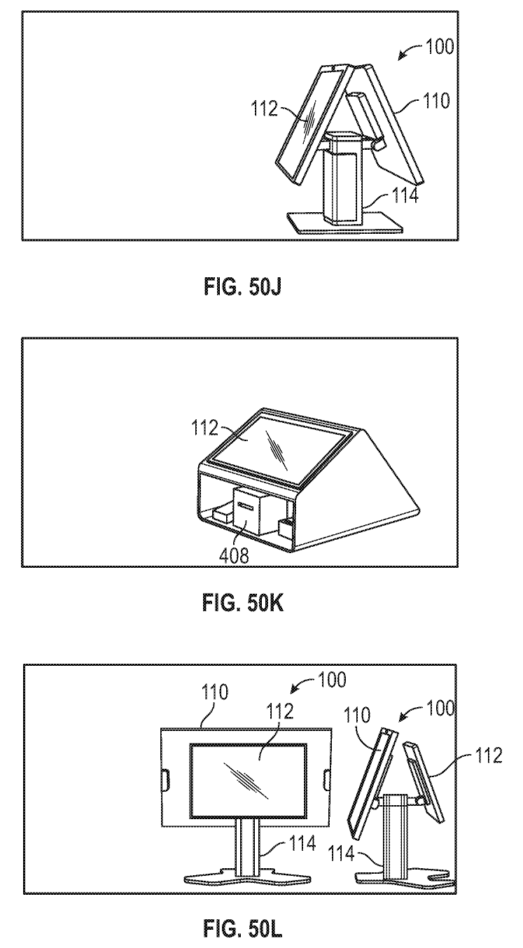

FIGS. 50A–50L illustrate the modularity and configurability of the POS system 10, in accordance with at least one embodiment. The modularity of the POS system 10 (e.g., modular hub architecture) can facilitate adaptation in different types of environments or use cases. The modular POS terminal can allow for stock keeping unit (SKU) flexibility for restaurants, retail, semi-outdoor use, or other types of facilities, for example. The resultant POS terminals can support different operating systems (OS) including, for instance, Android, Windows, macOS, or Linux.

The POS system 10 can provide for various use cases and benefits. For example, the modular POS system 10 discussed herein can be installed readily and quickly. The modular POS system 10 can provide a clean installation, e.g., cables not visible or at least not apparent, or being less visible, over the base of the POS terminal. The POS system 10 can be facilitated by PoE, simplifying the setup process and reducing clutter. The modular design can allow for upgrades to be performed on a POS terminal, facilitating updating with reduced resource consumption. For instance, components of a POS terminal can be replaced by detaching a panel from the mounting structure and removing the housing to access the various components, without requiring special or dedicated tools. Maintenance procedures can be performed on the components once accessible.

The modular POS terminal can integrate a merchant-facing display (e.g., the MFD assembly 110) with the motherboard, supporting PoE for streamlined power and connectivity. The MFD assembly 110 and the CFD assembly 112 can support VESA mounting, allowing flexible placement on surfaces, e.g., on walls, counters, pillars, poles, or kiosks, thereby allowing installations in various environments. The processing units (e.g., CPU, GPU, etc.) can be independently upgradable, extending the lifecycle of the terminal and allowing for adaptability.

The vertical stand 114 and the low-profile stand 130 can each include an extension hub 54 that supports a variety of input types in addition or alternative to the interface ports 146 of the MFD assembly 110. The modular extension hub 54 can be mounted in different locations, such as within the vertical stand 114, on the rear of the MFD assembly 110, or under a counter, providing versatile installation options. The MFD assembly 110 and the CFD assembly 112 can connect to the extension hub 54 using a USB-C interface, for example, which supports both on-the-go (OTG) and power delivery (PD) standards, ensuring streamlined connectivity and efficient power delivery.

FIGS. 50A–50L provide examples of the modularity of the POS terminal. For example, FIG. 50A illustrates a top view of the POS terminal, including two panels that oppose each other (e.g., facing in opposite directions from each other). The top 222 of the vertical stand 114 (e.g., sometimes referred to as a stand cover or one of the stand covers) can be constructed into a bracket allowing the positioning of the displays at various angles. Various modules or components can be mounted on each side of the top 222 to facilitate adjusting these angles. The angle can be configurable or adjustable via the bracket or joint attached between the vertical stand and the panel(s) (e.g., the attachment point 124 and the attachment point 126). In some embodiments (e.g., as shown in FIG. 50A), the panels can be tilted or rotated at least along a vertical axis for tilting the panel side to side, using the joint or bracket. By providing the adjustable bracket, the panels can be tilted, for instance, such that users are not required to move along a counter when handling items (e.g., goods or products at a store) and completing the transaction or payment. With the screens or panels angled towards the users, the terminal can be positioned relatively close to a wall in confined spaces while allowing proper viewing angles for users.

FIG. 50B illustrates a side view of the POS terminal, showcasing the low-profile stand 130 (e.g., for the second panel) constructed or designed to also fit the main display (e.g., the MFD assembly 110). In this case, the MFD assembly 110 and the CFD assembly 112 can be installed on respective low-profile stands 130, which raise and tilt the panels to a predefined height and viewing angle. Such a configuration of the panels (or displays) can facilitate a relatively more natural interaction between the users during a transaction (e.g., facilitating face-to-face interaction between users without the POS terminal obstructing their view). The ergonomic design can provide a relatively more comfortable wrist angle for users using the screen, enhancing user experience and reducing strain when used over an extended duration. Additionally, the construction or design of the low-profile stands 130 can facilitate integration into bars, counters, or other environments, allowing accessories such as printers to be hidden under the screen, for example.

FIG. 50C illustrates a relatively flat platform with accessories of different sizes and characteristics, configured to manage cables from side products and accessories, such as receipt printers or card readers. As shown, the base assembly of the vertical stand 114 can include a relatively flat (or substantially planar) platform. One or more substantially planar platforms can be placed or coupled to the side of the base assembly. Accessories may be placed on a platform. The platforms can be coupled to each other via a suitable coupling mechanism, such as a magnet. In some cases, the platforms may be placed next to each other without coupling. Such configurations permit a simplified appearance by concealing or limiting visibility of cables connecting from the POS terminal to at least one accessory.

FIG. 50D illustrates a relatively flat platform accessory including an extended base plate configured with a 90° angle, as an example. The accessories can be configured in different sizes and characteristics, for instance, constructed or designed to manage cables from side products and accessories, such as receipt printers, card readers, or other devices with cables routing to the POS terminal. As shown in FIG. 50D, the 90° extended base plate can allow the POS terminal to be placed on top of a register (or any other elevated platform) without exposing the cables, for example. In this case, the extended base plate can facilitate concealment of at least a majority of cables associated with the POS terminal.

FIG. 50E illustrates a panel (e.g., an MFD assembly 110) mounted to a wall, such as using a VESA bracket. FIG. 50F illustrates the panel mounted to the wall using a bracket that allows for tilting the display. The bracket may be a VESA edge hinge, for example. FIG. 50G illustrates an MFD assembly 110 mounted to the vertical stand 114 and the CFD assembly 112 mounted to a wall (e.g., the counter wall) using a wall mount. In this case, a hinge can be utilized to mount via the top of the CFD assembly 112, thereby facilitating tilting the CFD assembly 112 vertically, such as around the lateral axis for tilting the screen up or down. Such a configuration can facilitate a relatively more versatile and space-efficient placement by freeing space on the horizontal surface.

FIG. 50H illustrates a wall mount with a VESA arm for a display or panel. A bracket can be used to allow for tilting the panel sideways as well as allowing horizontal translation. The versatile wall mount can accommodate a plurality of viewing angles and workstation setups, providing flexibility in positioning the display. The arm can be folded, allowing for concealment of one or more cables. The solid mount can be constructed to allow for one-hand interaction, e.g., tilting or moving the display with one hand. In some configurations, a connector hub can be implemented as part of the wall mount. The wall mount can allow for four dimensions of panel adjustability. The adjustment can be locked, such that the panel is fixed in a desired position after adjustment.

FIG. 50I illustrates an integrated mount configured for slanted or substantially planar surfaces, such as counters, tabletops, or stands. The mount or bracket can allow for seamless integration with existing fixtures, architectural elements, or furniture. The mount can facilitate the placement of the one or more panels onto various non-limiting surfaces. Cables can be concealed within the structure on which the panel is placed.

FIG. 50J illustrates an enlarged customer-facing user interface (UI). In this case, the MFD assembly 110 and the CFD assembly 112 may include similar dimensions to improve user experience and UI interaction for users. FIG. 50K illustrates a storage stand for the panel (e.g., the CFD assembly 112). In this case, the panel can be installed or implemented in the storage stand, elevating and angling the panel. In such a configuration, a storage space can be provided under the display while allowing certain products and accessories (e.g., printers, card readers, etc.) to be concealed. FIG. 50L illustrates a streamlined (e.g., slenderized) stand configuration for the POS terminal. In this case, the extension hub can be removed from the vertical stand 114 or the vertical stand 114 may lack a cavity, thereby reducing the dimension (e.g., width or depth) of the vertical stand 114.

The POS system 10 may include various accessories or components to facilitate providing the arrangements of FIGS. 50A–50L. As described in conjunction with at least FIG. 50A, the vertical stand 114 can include a bracket (e.g., attachment point) installed at the top of the vertical stand 114 to allow mounting and pivoting the one or more panels. As described in conjunction with at least FIG. 50D, the POS system 10 can include various platform accessories for enhanced aesthetics and minimization of exposed componentry, e.g., by concealing one or more cables under the platforms.

The mounting structure, attachment points, or accessories of the POS system 10 can have different configurations and features that can be adapted to satisfy preferences or criteria for different environments of the terminal. The components discussed herein may include variations in size, shape, mounting options, etc. For instance, the base assembly 120 can be rectangular, triangular, or have one or more curvilinear elements. The base assembly 120 may be relatively planar or curved relative to a surface. The various designs can include different techniques to assemble the front and back plate (e.g., the cable cover 220) for the vertical stand 114, e.g., to couple the panel (e.g., MFD assembly 110) on the mounting structure. In some configurations, the mounting structure can include a rail for adjusting the panel vertically. In some implementations, the height of the mounting structure may be adjustable. The POS terminal can be implemented in different materials and finishings.

Certain embodiments can avoid or reduce a visible gap between the display device (e.g., CFD assembly 112) and the stand (e.g., the low-profile stand 130), and the absence of such a gap can enhance the visual continuity of the design. In various implementations, the enclosure alignment and mounting interface can be refined to eliminate the gap. For example, the enclosure alignment and mounting interface can be adjusted such that the CFD assembly 112 sits flush with the low-profile stand 130 to provide a seamless appearance.

FIG. 30 illustrates an alignment of radius profile for components of the POS terminal. The corner radii of, for instance, any one or more of the display bezel of the housing 140, VESA mount (e.g., the housing expansion 142) and the base plate 120, and the surface radius of the display (e.g., the MFD 40), the stand cap or cover (e.g., the top 222), the vertical column (e.g., the support column 122), base, and column to cover plates can influence the overall appearance of the terminal. Thus, in at least one embodiment, a consistent radius profile or theme can be implemented or adopted. In some configurations, the corner radii of the display bezel, stand base, and column edges, etc. can be aligned to provide a unified appearance.

The various components of the POS system 10 may include inset logos (e.g., images and/or text) that are formed on one or more components. At least one logo (e.g., sometimes referred to as a mark, symbol, or engraving) can be engraved, etched, or included on at least a part of the POS terminal. For example, a logo can be included as part of the pillar or stand of the POS terminal or at the back of the panel or display device (e.g., the MFD assembly 110 or the CFD assembly 112). The depth and size of the logo can be configured or predetermined. In some cases, a logo with a depth that is relatively too deep, e.g., greater than a threshold, may collect debris and/or have an undesirable appearance. As such, the logo can be configured to be relatively shallower (e.g., at or below the threshold) with a predefined size. For instance, the logo can be etched to about 0.3 mm to about 0.5 mm in depth, for example. Other parameters associated with the logo, including at least one of, but not limited to, the size, depth, shape, or texture, can be used. In some implementations, the logo may be protruded from the surface of the POS terminal component, not limited to etching into the surface of the component. In some other cases, laser engraving or at least one other suitable engraving technique can be executed to generate/form the logo while maintaining the depth of the surface of the component.

The rear/backside of the display device (e.g., panel) can include a connector box (e.g., the housing expansion 142) including at least one of cables, ports, or the VESA mount. In some embodiments, a refined surface texture can be applied to the rear of the display device and/or the cover plate of the stand. Examples of the refined surface texture can include at least one of, but are not limited to, a brushed metal finish, matte satin coating, micro-textured gloss, or a soft-touch texture. Other types of texture or materials can be utilized.

The vertical stand 114 may have various surface finishes. In various configurations, anodized aluminum can be selected. An anodized finish can provide relatively higher durability, refined consistency, and environmental friendliness. Anodizing the material can create a hard, non-corrosive oxide layer that is integrated into the (e.g., aluminum) surface itself instead of a coating on top of the surface. With such a technique, the material can be relatively more resistant to scratches, abrasion, UV damage, fading, peeling, flaking, or chipping compared to certain paint coatings.

In further examples, anodizing can provide a refined and consistent finish, resulting in a smoother surface and uniform color and texture across batches of produced components. Further, the anodizing process can avoid potential issues such as running paint, drips, or uneven gloss, for example. The anodized finish can enhance the natural metallic character of aluminum (or other materials), thereby contributing to the device’s overall aesthetic aspects. Additionally, the execution of the anodizing process can be environmentally friendly, characterized by low volatile organic compound (VOC) emissions, which results in a relatively minimal environmental impact compared to certain paint-based finishes. Although the finish of one or more components of the POS terminal can be anodized, other suitable coating or finishing techniques can be utilized, not limited to anodization.

Beneficially, the POS system 10 may be quickly and easily reconfigurable to suit a variety of different applications. The components of the POS system 10 may have standardized interfaces that permit removably and interchangeably coupling the components to one another. By way of example, the low-profile stand 130 may include a standardized interface (e.g., a VESA mount) that is capable of interchangeably coupling to the MFD assembly 110, the CFD assembly 112 with the payment interface 52, and the CFD assembly 112 without the payment interface 52. Accordingly, any of the panels described herein may be usable with the low-profile stand 130. By way of example, the MFD assembly 110 and the CFD assembly 112 of the POS terminal 100 in FIG. 4 may be removed from the vertical stand 114 and each coupled to a low-profile stand 130 to form the arrangement of FIG. 50B. The MFD assembly 110 and the CFD assembly 112 may then be coupled by a cable 132, in communication wirelessly, or used separately (e.g., with the MFD assembly 110 on a low-profile stand 130 as a standalone POS terminal). By way of another example, the extension hub 54 may include mounting provisions that permit fastening, inserting, or otherwise coupling the extension hub 54 with the MFD assembly 110, the vertical stand 114, and the low-profile stand 130. By way of another example, the merchant accessories 50 such as the MSR assembly 170, the payment interface assembly 180, and the fingerprint reader 190 may be usable with any of the expansion slots 160 shown herein. This may facilitate moving a merchant accessory 50 between different POS terminals or between the left and right sides of a MFD assembly 110. Alternatively, the MFD assembly 110 may be utilized without any merchant accessories 50. By way of another example, the CFD assembly 112 with the payment interface 52 and the MFD assembly 110 without the payment interface 52 may have standardized interfaces that permit interchanging with one another (e.g., based on whether a payment interface 52 is required).

Referring to FIG. 51, a modular point-of-sale (POS) platform, POS system, payment system, inventory system, computing system, sales system, or kiosk system, is shown as POS system 400 according to an exemplary embodiment. The POS system 400 may be used by a person, individual, or customer to complete a transaction. The transaction may include an exchange of goods (e.g., food, items, etc.), services, and/or financial instruments (e.g., cash, paper checks, electronic funds through credit or debit cards, etc.) between the customer and a merchant. By way of example, the transaction may include a purchase of a food product at a restaurant, a return of a product in a retail store in exchange for previously-provided funds, a checking out of a book at a public library, or other types of transactions. During the transaction, the POS system 400 may facilitate identifying a good or service to be exchanged (e.g., a selection of a food order), identify a corresponding type and amount of financial instrument required for the transaction (e.g., a total cost of the order as well as how the customer intends to pay), initiate a transfer of funds (e.g., between a customer bank account or credit provider and a merchant bank account), and/or track changes in inventory (e.g., to identify sales metrics and when a particular good should be replenished). This action may be performed locally (e.g., within a restaurant or store) and/or remotely (e.g., through one or more remote servers). The POS system 400 may represent an alternative configuration of the POS system 10. The POS system 400 may differ from the POS system 10 in that the POS system 400 includes a single display assembly that is operated by a customer to place their own order (e.g., in a self-checkout or self-service purchasing arrangement).

The POS system 400 includes a compute module 20 that controls operation of the POS system 400. The compute module 20 may have similar structure and functionality to the compute module 20, except as otherwise specified herein. Accordingly, any description of the compute module 20 of the POS system 10 may apply to the compute module 20 of POS system 400.

As shown, the compute module 20 is coupled via the bus 22 to a display or visual output device, shown as display 402. The display 402 may be a liquid crystal display, active matrix display, or other type of display for visually displaying information to a user. The display 402 may be controlled by the compute module 20 to display information (e.g., in the form of a GUI) that is relevant to the customer (e.g., a GUI offering various available order selections or customizations, a GUI used to verify the accuracy and completeness of the customer’s order). Accordingly, the display 402 may display information related to a transaction. The display 402 may be positioned to be viewed by the customer (e.g., in an area accessible to a customer, etc.).

The POS system 400 further includes one or more input devices, shown as input devices 404, coupled to the bus 22 for communicating information and commands to the processor 24. The input devices 404 can include a touch screen portion of the display 402. The input devices 404 may include other input devices, such as a keyboard or voice interface. The input devices 404 can also include a cursor control, such as a mouse, a trackball, or cursor direction keys, for communicating direction information and command selections to the processor 24 and for controlling cursor movement on the display 402.

The POS system 400 further includes one or more payment interfaces 406. The payment interfaces 406 may be positioned to be utilized by a customer. The payment interfaces 406 may include a scanner, a radio-frequency identification (RFID) reader, a magnetic stripe reader, an inserted chip (e.g., EMV) reader, and/or a near-field communication (NFC) reader. The payment interfaces 406 may communicate with a payment card (e.g., a credit or debit card) and/or a user device (e.g., an NFC-enabled smartphone). The payment interfaces 406 may enable a customer to utilize a payment card or user device to initiate a transaction or otherwise provide information to the POS system 400.

The POS system 400 further includes one or more expansion devices, output devices, image forming devices, or receipt printers, shown as printer 408, operatively coupled to the processor 24 through the bus 22. The compute module 20 may control the printer 408 to form a desired image on an image recording medium (e.g., a sheet of paper). By way of example, the printer 408 may form an image using ink or toner, by heating a thermally-sensitive image recording medium, or through another type of printing. The printer 408 may generate a receipt recording the details of a transaction (e.g., a total cost, types and quantities of purchased goods, an order number, etc.).

The POS system 400 further includes one or more expansion devices, output devices, alarms, notification devices, or accessories, shown as light bar 410, operatively coupled to the processor 24 through the bus 22. The light bar 410 may be added to the POS system 400 to facilitate communicating information to a user. Specifically, the light bar 410 may emit light in a particular pattern or color to visually communicate information to a customer, merchant, or other user. By way of example, the light bar 410 may communicate a status of the POS system 400 (e.g., whether a POS terminal is available, in use, out of order, etc.).

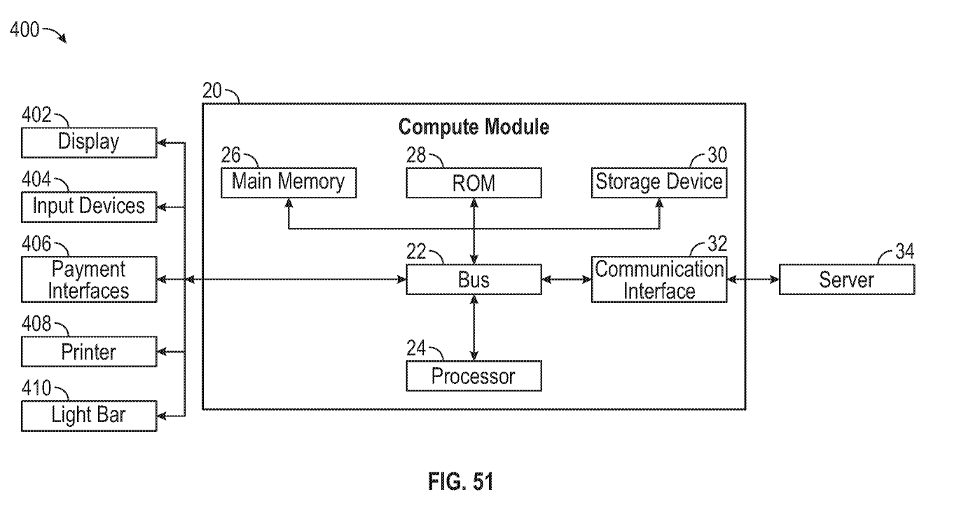

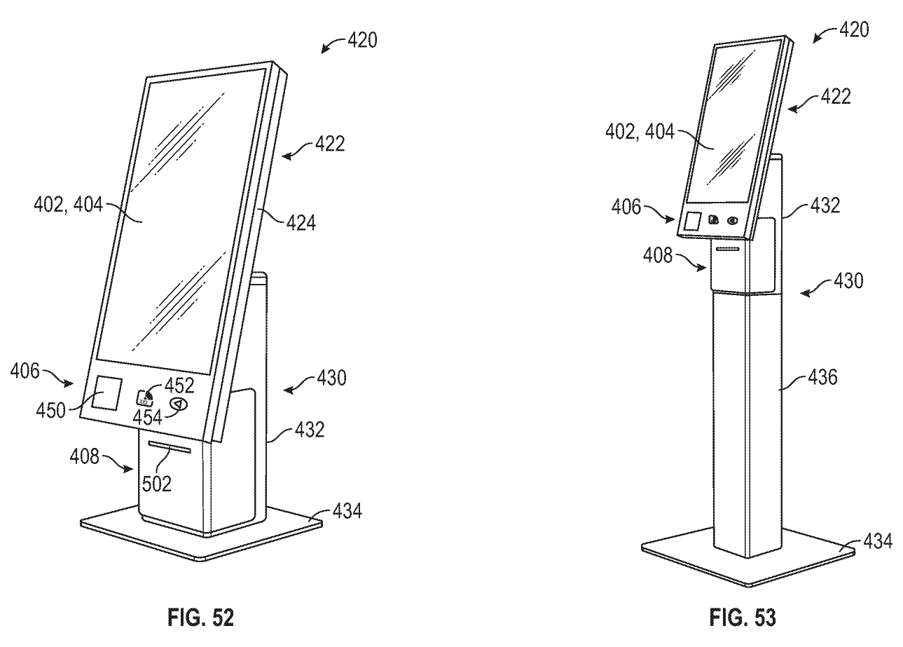

Referring to FIG. 52, a configuration of the POS system 400 is shown according to an exemplary embodiment. In the embodiment of FIG. 52, the POS system 400 forms a self-service POS terminal, shown as kiosk 420. The kiosk 420 includes a customer-facing display assembly or panel, shown as display assembly 422. The display assembly 422 includes a chassis, housing, frame, or enclosure, shown as housing 424, that supports and contains the other components of the display assembly 422. The housing 424 supports a touchscreen display that serves as both the display 402 and the input devices 404. The housing 424 further contains the compute module 20 and the payment interfaces 406. The display assembly 422 may have similar functionality to the CFD assembly 112.

The kiosk 420 further includes a support, podium, or stand, shown as stand assembly 430, that supports the display assembly 422 on a support surface, such as a countertop, floor, or ground surface. The stand assembly 430 may be hollow to permit routing cables through the stand assembly 430. The stand assembly 430 includes an upper portion, interface portion, or printer portion, shown as interface portion 432, that is coupled to a rear side of the housing 424 (e.g., with a VESA mount) and extends downward from the display assembly 422. As shown, the interface portion 432 contains the printer 408. The stand assembly 430 further includes a bottom portion or base, shown as base assembly 434, that is coupled to a bottom end portion of the interface portion 432. The base assembly 434 may be or include a base plate, a supporting platform, a mounting plate, or a bottom portion of the interface portion 432, for example. The interface portion 432 extends substantially vertically from the base assembly 434 to the housing 424.

FIG. 53 illustrates an alternative configuration of the kiosk 420. In the kiosk 420 of FIG. 53, the stand assembly 430 further includes an extension, support column, stand, or podium, shown as stand extension 436. The stand extension 436 extends between the interface portion 432 and the base assembly 434, raising the interface portion 432 and the display assembly 422 relative to the base assembly 434. The height of the display assembly 422 in the kiosk 420 of FIG. 52 may be shorter than the height of the display assembly 422 in the kiosk 420 of FIG. 53. The kiosk 420 of FIG. 52 may be placed atop a counter, table, or other elevated surface, such that the kiosk 420 is a countertop kiosk. The kiosk 420 of FIG. 53 may be placed on a floor or ground surface, such that the kiosk 420 is a floor-standing kiosk. Accordingly, the kiosk 420 may be configured for use on surfaces of different heights by adding or removing the stand extension 436.

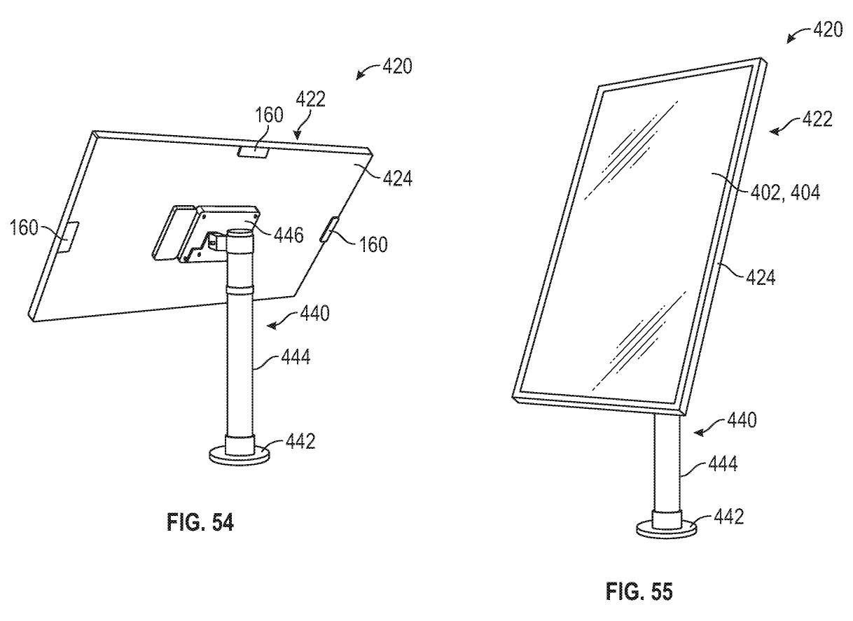

FIGS. 54 and 55 illustrate another alternative configuration of the kiosk 420. In the kiosk 420 of FIGS. 54 and 55, the stand assembly 430 is omitted and replaced with a support, stand, podium, or stand assembly, shown as mount arm 440. The mount arm 440 includes a bottom portion or base 442 that is configured to be coupled (e.g., bolted) to a countertop or other object. A support column or riser, shown as support column 444, extends upward from the base 442 to a mount or attachment point, shown as connection interface 446. The connection interface 446 is coupled to a rear side of the housing 424 (e.g., with a VESA mount). The mount arm 440 may be fixedly coupled (e.g., bolted) to another object (e.g., a counter) and may have a relatively smaller footprint than the stand assembly 430. The connection interface 446 may be reconfigurable to hold the display assembly 422 in a landscape or horizontal orientation (e.g., shown in FIG. 54) or a portrait or vertical orientation (e.g., shown in FIG. 55).

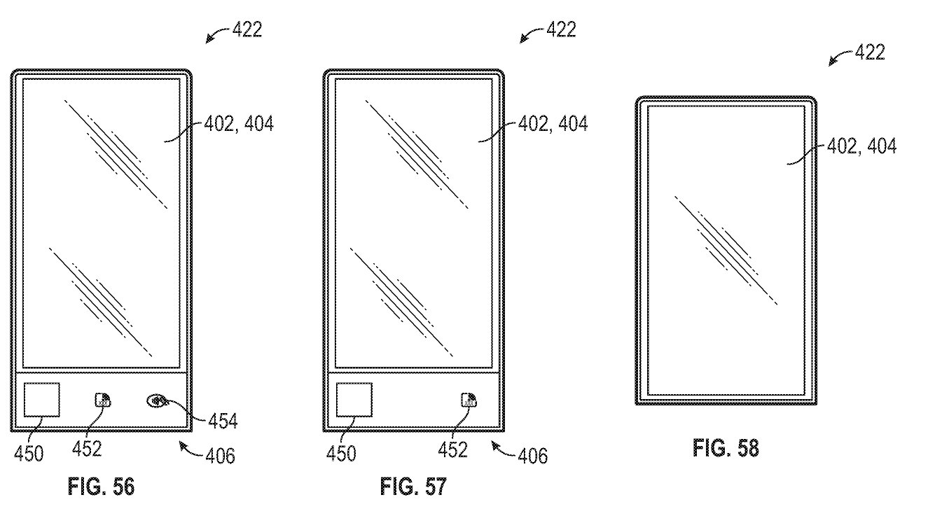

In the display assembly 422 of FIG. 56, the payment interfaces 406 include a scanner 450, an RFID reader 452, and an NFC sensor 454. The scanner 450 may be a laser or other type of image-based scanner configured to visually read information. The scanner 450 may read information from a bar code or other visual indicator. By way of example, the scanner 450 may be used to scan a bar code on a product, ticket, or coupon to receive information related to a transaction. The RFID reader 452 may utilize radio waves to read information stored on an RFID tag (e.g., on a product). The NFC sensor 454 may communicate with an NFC-enabled payment device (e.g., a payment card or user device). The NFC sensor 454 may provide similar functionality to the NFC sensor 184.

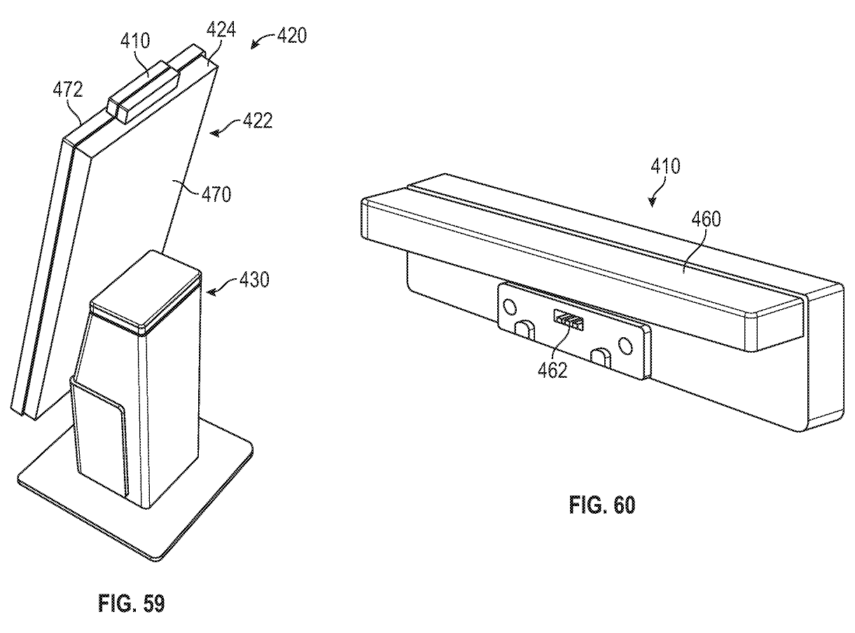

Referring to FIGS. 56–58, the payment interfaces 406 may be reconfigurable to include different components that provide different functionality. In the display assembly 422 of FIG. 56, the payment interface 406 omits the RFID reader 452 and instead includes only the scanner 450 and the NFC sensor 454. In the display assembly 422 of FIG. 57, the payment interface 406 is omitted entirely. Accordingly, the display assembly 422 may be scaled to meet the needs of a particular application of the POS system 400.

Referring to FIGS. 59 and 60, the light bar 410 is shown according to an exemplary embodiment. The light bar 410 includes a light-emitting element, shown as light source 460, configured to emit light. By way of example, the light source 460 may be a light-emitting diode (LED) light source. The light source 460 may be capable of varying one or more outputted properties of the light, e.g., one or more of the color, brightness (intensity), and/or flashing pattern of the light emitted by the light source 460. The light bar 410 further includes a connection interface, shown as electrical connector 462, that is configured to removably engage the display assembly 422 to selectively electrically couple the light source 460 to the compute module 20. The light bar 410 may be removable to add or remove the light bar 410 based on the desired functionality of the kiosk 420.

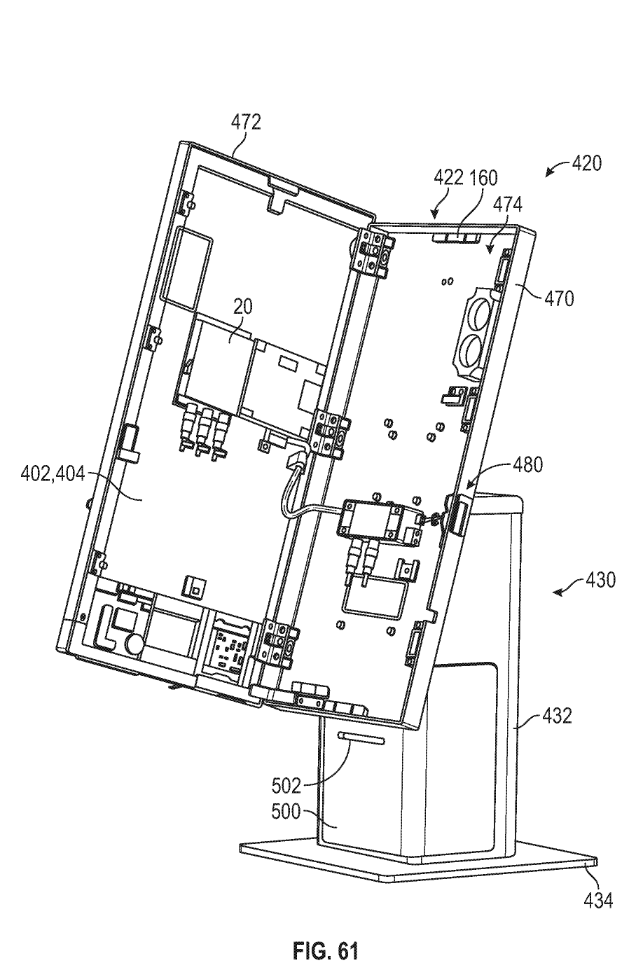

Referring to FIG. 61, the display assembly 422 of the kiosk 420 is shown to include a first portion or fixed portion, shown as back panel 470, and a second portion or movable portion, shown as front panel 472. The front panel 472 is pivotably coupled to the back panel 470 (e.g., by one or more hinges), such that the front panel 472 is rotatable relative to the back panel 470 about an axis of rotation (e.g., a vertical axis). The front panel 472 is movable between a closed position (e.g., as shown in FIG. 52) and an open position (e.g., as shown in FIG. 61). In the closed position, the front panel 472 and the back panel 470 define an enclosed volume or storage volume, shown as internal volume 474, between the back panel 470 and the front panel 472. The internal volume 474 may store one or more components of the display assembly 422 (e.g., the compute module 20). The internal volume 474 may be accessed (e.g., for maintenance) by moving the front panel 472 to the open position.

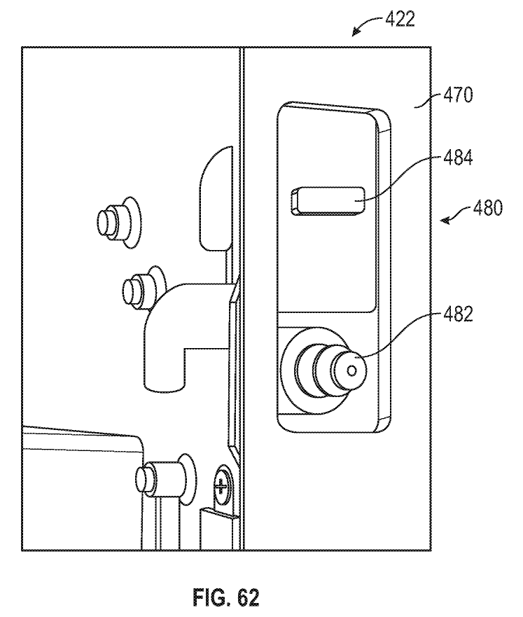

As shown in FIG. 62, the display assembly 422 includes a closure assembly or lock, shown as latch 480. The latch 480 is coupled to the back panel 470 and configured to selectively prevent movement of the front panel 472 from the closed position to the open position (e.g., to prevent unauthorized access to the internal volume 474). The latch 480 includes a locking mechanism, shown as lock body 482, that is coupled to the back panel 470. The lock body 482 may include a locking element (e.g., a pawl or catch) that engages the front panel 472 to limit movement of the front panel 472 with the lock body 482 in a locked configuration. The lock body 482 may be actuated by a user (e.g., by inserting and turning a key) to switch the lock body 482 between the locked configuration and an unlocked configuration. The latch 480 further includes a sliding cover, shown as cover 484, that is slidably coupled to the back panel 470. The cover 484 is movable between an open position (e.g., as shown in FIG. 62) in which the cover 484 permits access to the lock body 482 and a closed position in which the cover 484 obstructs access to the lock body 482.

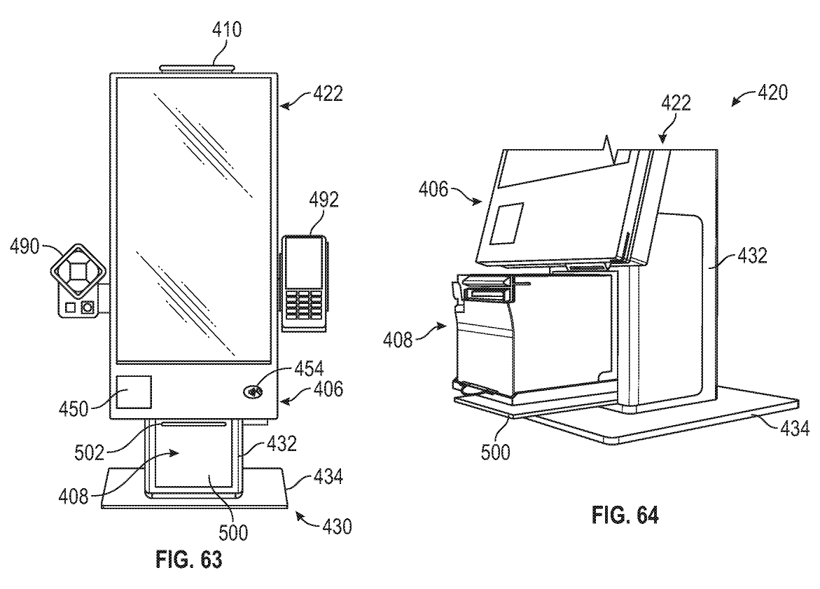

As shown in FIG. 63, the kiosk 420 may be equipped with one or more removable accessories or expansion devices that provide additional functionality to the display assembly 422. A first removable accessory, shown as accessibility interface 490, is removably coupled to the display assembly 422 on a first side of the display assembly 422. The accessibility interface 490 may be in communication with the compute module 20 (e.g., through an expansion slot similar to the expansion slot 160) and may serve as an input device 404. The accessibility interface 490 may include physical interface devices (e.g., buttons, switches, joysticks, etc.) that can be operated by a user to interact with the display assembly 422. The accessibility interface 490 may provide access to functionality that would otherwise be controlled through a touchscreen of the display assembly 422. The accessibility interface 490 may provide an alternative option for controlling the display assembly 422 to an individual who may have particular accessibility needs or difficulty in operating a touchscreen display.

A second removable accessory, shown as payment interface 492, is removably coupled to the display assembly 422 on a second side of the display assembly 422. The payment interface 492 may be in communication with the compute module 20 (e.g., through an expansion slot similar to the expansion slot 160) and may serve as a payment interface 406. The payment interface 492 may include a keypad, a screen, a magnetic stripe reader, an EMV reader, an NFC sensor, and/or another type of payment interface. Beneficially, the payment interface 492 may accept additional or alternative types of payment than the payment interfaces 406 built into the display assembly 422, or the payment interface 492 may process payments in a different way (e.g., through a different institution).

Referring to FIGS. 52 and 64–66, the interface portion 432 of the stand assembly 430 acts as a housing, defining an internal volume that receives the printer 408. The interface portion 432 includes a door, cover, or hatch, shown as printer door 500, that covers the printer 408 and retains the printer 408 within the interface portion 432. Accordingly, the stand assembly 430 may include a built-in printer 408 (e.g., instead of relying on an external printer). The printer door 500 defines an aperture or slot, shown as printer slot 502, that aligns with an outlet of the printer 408 to permit access to printed material outputted by the printer 408 (e.g., a receipt or ticket).

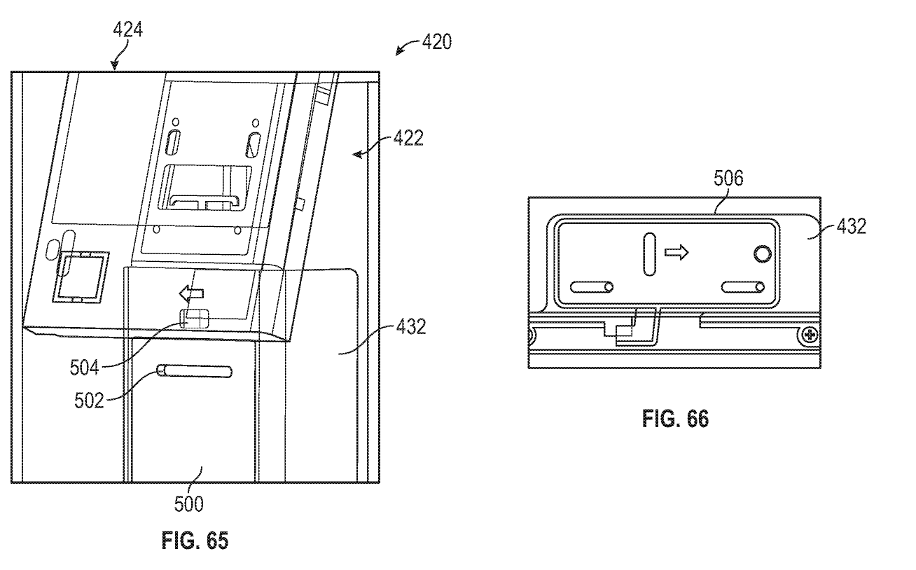

The printer door 500 can be moved from a closed position (e.g., as shown in FIG. 65) to an open position (e.g., as shown in FIG. 64) to permit insertion of the printer 408 into the interface portion 432 and removal of the printer 408 from the interface portion 432 (e.g., for maintenance, such as adding paper to the printer 408). An interface, shown as slider 504, controls a lock or latch, shown as latch 506, to selectively prevent the printer door 500 from being moved to the open position. As shown, the slider 504 is fixedly coupled to the latch 506, and the latch 506 is slidably coupled to an internal surface of the interface portion 432. The slider 504 may be positioned on an exterior surface of the interface portion 432, such that the slider 504 may be accessed by a user to engage or disengage the latch 506. As shown, the slider 504 may be partially obscured by the display assembly 422 to limit visibility of the slider 504 and impede tampering.

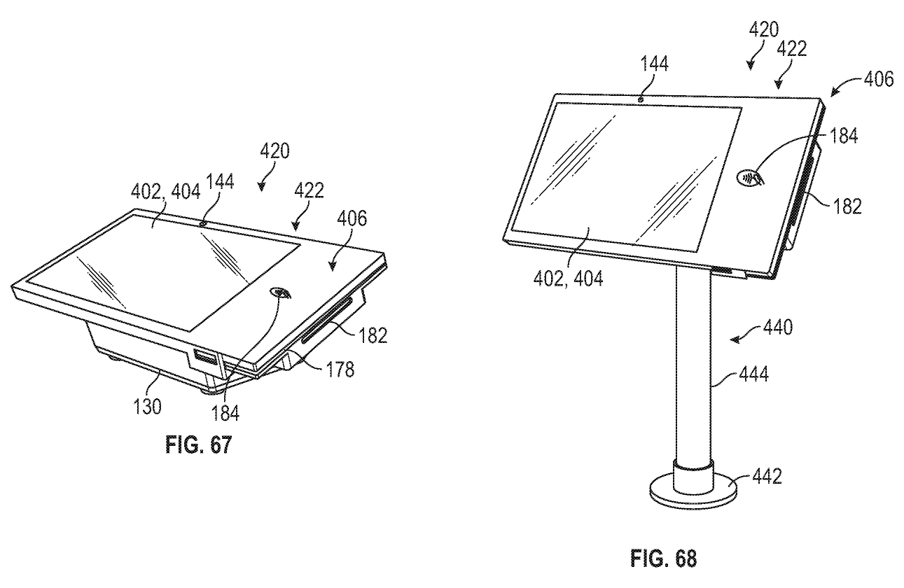

Referring to FIGS. 67 and 68, an alternative embodiment of the display assembly 422 is shown according to an exemplary embodiment. The display 402 of FIGS. 67 and 68 may be smaller than the display 402 of FIG. 52 (e.g., approximately 10.1” (measured diagonally) and 21.5” (measured diagonally), respectively). Beneficially, the smaller screen 402 of FIGS. 67 and 68 may provide a similar form factor to the CFD assembly 112, such that the display assembly 422 may be utilized in a similar manner to the CFD assembly 112. However, the display assembly 422 may differ from the CFD assembly 112 in that the display assembly 422 may not communicate with or otherwise rely upon an MFD assembly 110 to complete a transaction. As shown in FIG. 67, the display assembly 422 may be supported by a low-profile stand 130 to form a kiosk 420. As shown in FIG. 68, the display assembly 422 may be supported by a mount arm 440 to form a kiosk 420. In other embodiments, the low-profile stand 130 and the mount arm 440 are omitted, and the display assembly 422 is mounted to a wall (e.g., through a VESA mount).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

As used herein and in the appended claims, singular articles such as “a” and “an” and “the” and similar references in the context of describing the elements (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein, is intended merely to better illuminate the implementations and does not pose a limitation on the scope of the claims unless otherwise stated. No language in the specification should be construed as indicating any non-claimed element as essential.

Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned components or steps may be present. Unless otherwise specified, “a” or “an” means one or more.

Unless otherwise indicated, all numbers expressing quantities of properties, parameters, dimensions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation indicates approximations which may vary by ( + ) or ( - ) 10%, 5% or 1%, for example.

It is to be understood that to the extent that the present disclosure refers to certain preferred implementations, various other implementations and variants may occur to those skilled in the art, which are within the scope and spirit of the disclosure, and such other implementations and variants are intended to be covered by corresponding claims. Those skilled in the art will readily appreciate that many modifications are possible (e.g., variations in sizes, dimensions, structures, shapes and proportions of the various elements, mounting arrangements, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A terminal for a point-of-sale system, the terminal comprising:
a stand including a first attachment arm and a second attachment arm;
a first display assembly including a first housing removably coupled to the first attachment arm, a first display disposed in the first housing, and a controller coupled to the first housing; and
a second display assembly including a second housing removably coupled to the second attachment arm and a second display disposed in the second housing,
wherein the first display assembly faces opposite from the second display assembly, and wherein the controller is configured to control operation of the first display and the second display.

2. The terminal of claim 1, wherein the stand includes a base assembly and a column extending upward from the base assembly and supporting both the first attachment arm and the second attachment arm, the terminal further including an extension hub positioned within the column and including a plurality of interface ports, wherein the controller is operatively coupled to the second display through the extension hub.

3. The terminal of claim 2, wherein the stand further includes a cover coupled to a top end portion of the column, and wherein the cover is removable to permit access to at least one of the interface ports on the extension hub.

4. The terminal of claim 3, wherein the cover at least partially defines an aperture that receives the second attachment arm, and wherein the second attachment arm is removably coupled to the column.

5. The terminal of claim 2, wherein the stand further includes a cover coupled to a front side of the column, and wherein the cover is removable to permit access to at least one of the interface ports on the extension hub.

6. The terminal of claim 2, further comprising a cable coupling the controller of the first display assembly to at least one of the interface ports of the extension hub, and wherein the cable extends through the first attachment arm.

7. The terminal of claim 1, wherein the first housing includes a protruding portion extending rearward and away from the first display, wherein the protruding portion defines a plurality of first mounting apertures arranged in compliance with a Video Electronics Standards Association (VESA) Mounting Interface Standard (MIS) and positioned along a rear surface of the protruding portion, and wherein the protruding portion defines a plurality of second mounting apertures positioned along a bottom surface of the protruding portion and each configured to receive a fastener to couple the first housing to the first attachment arm.

8. The terminal of claim 1, wherein the stand includes a base assembly and a column extending upward from the base assembly, and wherein the second attachment arm is removably coupled to the column.

9. The terminal of claim 1, wherein the first attachment arm includes a joint configured to permit the first display assembly to rotate about at least one axis.

10. The terminal of claim 1, wherein the controller is configured to control the first display to display a graphical user interface (GUI) to present information related to a transaction.

11. The terminal of claim 1, wherein the controller is configured to control the second display to display a graphical user interface (GUI) to present information related to a transaction.

12. The terminal of claim 1, wherein the second display assembly includes a transaction interface operatively coupled to the controller and configured to receive payment information from a payment device.

13. The terminal of claim 1, wherein the first display assembly includes an expansion slot, further including an accessory removably coupled to the expansion slot and configured to communicate with the controller through the expansion slot, the accessory including at least one of (a) a fingerprint reader or (b) a transaction interface configured to receive payment information from a payment device.

14. The terminal of claim 13, wherein the expansion slot is a first expansion slot, wherein the first display assembly further includes a second expansion slot, and wherein the accessory is configured to be removed from the first expansion slot and coupled to the second expansion slot such that the accessory communicates with the controller through the second expansion slot.

15. The terminal of claim 1, wherein the first housing of the first display assembly includes a bezel around edges of the first display, and wherein the first display assembly includes an integrated camera enclosed by the bezel.

16. A point-of-sale (POS) system, comprising:
a display assembly including a housing, a display disposed in the housing, a first interface port coupled to the housing, and a controller coupled to the housing and in communication with the first interface port;
a stand including a base assembly, a column extending upward from the base assembly, and an attachment arm configured to be removably coupled to the housing; and
a hub including a plurality of second interface ports, wherein the hub is configured to be coupled to the first interface port to operatively couple the second interface ports with the controller,
wherein in a first configuration, the housing of the display assembly is coupled to the attachment arm of the stand, and the hub is received within the column of the stand, and wherein in a second configuration, the housing of the display assembly is disconnected from the stand and the hub is directly coupled to the housing of the display assembly.

17. The POS system of claim 16, wherein in the first configuration, the hub is coupled to the first interface port by a cable that extends through the attachment arm, and wherein in the second configuration, the hub is directly coupled to the first interface port.

18. The POS system of claim 17, wherein the display assembly is a first display assembly, the housing is a first housing, the display is a first display, the stand is a first stand, and the attachment arm is a first attachment arm, the POS system further comprising:
a second display including a second housing and a second display disposed in the second housing; and
a second stand having a height shorter than a height of the first stand,
wherein in the first configuration, the second display is coupled to a second attachment arm of the first stand and in communication with the controller through the hub, and wherein in the second configuration, the second display is coupled to the second stand and in communication with the controller through the hub.

19. The POS system of claim 16, further comprising a transaction interface configured to receive payment information from a payment device, wherein the transaction interface is configured to communicate with the controller through the hub in both the first configuration and the second configuration.

20. A method, comprising:
providing a stand including a base assembly, a column extending upward from the base assembly, a first attachment arm coupled to the column, and a second attachment arm coupled to the column;
assembling a communication hub with the column;
providing a first display assembly including a first display disposed on a first side of the first display assembly, a first mounting interface disposed on a second side of the first display assembly, opposite from the first side of the first display assembly, and a controller configured to control the first display;
coupling the first mounting interface to the first attachment arm of the stand;
providing a second display assembly including a second display disposed on a first side of the second display assembly and a second mounting interface disposed on a second side of the second display assembly, opposite from the first side of the second display assembly;
coupling the second mounting interface to the second attachment arm of the stand such that the first display and the second display each face in opposing directions; and
connecting the second display to the controller through the communication hub.

21. A kiosk for a point-of-sale system, the kiosk comprising:
a display;
a controller configured to control the display to display a graphical user interface (GUI) to present information related to a transaction;
a housing containing the display and the controller;
a stand including a base assembly and an interface portion coupled to a side of the housing opposite the display, the interface portion extending above the base assembly; and
a printer positioned within the interface portion, wherein the controller is configured to control the printer to print a receipt containing the information related to the transaction.

22. The kiosk of claim 21, wherein the interface portion includes a door that is repositionable to selectively permit removal of the printer from the interface portion, further comprising a latch slidably coupled to the interface portion and configured to selectively limit movement of the door.

23. The kiosk of claim 21, further comprising a support column, wherein in a first configuration the interface portion is directly coupled to the base assembly, and wherein in a second configuration a support column extends between the interface portion and the base assembly to raise the display relative to a position of the display in the first configuration.

24. The kiosk of claim 21, further comprising at least one of a scanner, a radio-frequency identification (RFID) reader, or a transaction interface configured to receive payment information from a payment device, wherein the at least one of the scanner, the RFID reader, or the transaction interface is positioned within the housing and in communication with the controller.

25. The kiosk of claim 21, further comprising a light bar removably coupled to the housing and configured to emit light, and wherein the controller is configured to control the light bar to vary an outputted property of the light.
